(19) United States
(12) Patent Application Publication
(10) Pub. No.: US 2025/0148823 A1
(43) Pub. Date: May 8, 2025

(54) DISPLAY DEVICES AND METHODS OF CONTROLLING DISPLAY DEVICES

(71) Applicant: Samsung Display Co., LTD., Yongin-si (KR)

(72) Inventors: BYUNG HAN YOO, Yongin-si (KR); DAE-YOUNG LEE, Yongin-si (KR); GUN HEE KIM, Yongin-si (KR); SUNGCHUL KIM, Yongin-si (KR); YONGJO KIM, Yongin-si (KR)

(21) Appl. No.: 18/817,022

(22) Filed: Aug. 27, 2024

(30) Foreign Application Priority Data
Nov. 2, 2023 (KR) 10-2023-0150236

(51) Int. Cl. G06V 40/13; G06F 3/041; G06F 3/044; G06F 21/32; H10K 59/40; H10K 102/00

(52) U.S. Cl. CPC G06V 40/1306; G06F 3/0416; G06F 3/0447; G06F 21/32; H10K 59/40; G06F 2203/04102; H10K 2102/311

(57) ABSTRACT

In a method of controlling a display device, the display device including a display panel in which a display area is defined and including a plurality of pixels and a plurality of sensors, and an input sensing layer on the display panel and sensing an external input, the method includes allowing a first pixel of a first sensing area to emit a light, sensing first biometric information, matching the first biometric information with stored first authentication information, allowing a second pixel of a second sensing area to emit a light, sensing second d biometric information, matching the second biometric information with stored second authentication information, and driving the display panel.

### CROSS-REFERENCE TO RELATED APPLICATION

The present application claims priority to and the benefit of Korean Patent Application No. 10-2023-0150236 filed on Nov. 2, 2023, in the Korean Intellectual Property Office, the entire disclosure of which is incorporated herein by reference.

### BACKGROUND

Aspects of some embodiments of the present disclosure described herein relate to a display device with a relatively improved security strength and a method of controlling the display device.

A display device displays images such that information is provided to a user or provides various functions, which enable organic communication with the user, such as a function of sensing an input of the user. A display device may also include a function for sensing biometric information of the user.

The biometric information may be recognized by using a capacitive method of sensing a change in capacitance formed between electrodes, an optical method of sensing an incident light through a light sensor, an ultrasonic method of sensing vibration by utilizing a piezoelectric body, etc.

The above information disclosed in this Background section is only for enhancement of understanding of the background and therefore the information discussed in this Background section does not necessarily constitute prior art.

### SUMMARY

Aspects of some embodiments of the present disclosure include a display device with a relatively improved security strength and a method of controlling the display device.

According to some embodiments, a method of controlling of a display device which includes a display panel in which a display area is defined and including a plurality of pixels and a plurality of sensors, and an input sensing layer on the display panel and sensing an external input may include allowing a first pixel among the plurality of pixels to emit a light, the first pixel being in a first sensing area of the display area, which overlaps the external input, sensing, at a first sensor among the plurality of sensors, first biometric information from the external input, the first sensor being in the first sensing area, matching the first biometric information with stored first authentication information, allowing a second pixel among the plurality of pixels to emit a light, the second pixel being in a second sensing area of the display area, which overlaps the external input and is different from the first sensing area, sensing, at a second sensor among the plurality of sensors, second biometric information different from the first biometric information from the external input, the second sensor being in the second sensing area, matching the second biometric information with second authentication information different from the stored first authentication information, and driving the display panel when the first biometric information is matched with the first authentication information or when the second biometric information is matched with the second authentication information.

According to some embodiments, allowing of the second pixel to emit the light may be performed when the first biometric information and the first authentication information are not matched with each other.

According to some embodiments, the external input may include a hand of a user, and the first biometric information may include a fingerprint of a thumb of the hand of the user.

According to some embodiments, the second biometric information may include a fingerprint of an index finger of the hand of the user.

According to some embodiments, the second biometric information may include a palm of the hand of the user.

According to some embodiments, the display device may further include a sensing unit sensing a direction of the display device, the method may further include sensing, at the sensing unit, the direction of the display device, and the sensing of the direction of the display device may include allowing the first pixel of the first sensing area to emit the light when the display device is in a forward direction.

According to some embodiments, allowing of the first pixel to emit the light may include sensing, at the input sensing layer, coordinates of the external input, defining the first sensing area based on the coordinates, and allowing the first pixel overlapping the first sensing area from among the plurality of pixels to emit the light.

According to some embodiments, the first pixel may be adjacent to the first sensor, and the second pixel may be adjacent to the second sensor.

According to some embodiments, the display may area include a first area including a first edge, a second edge extending in a direction intersecting the first edge, a third edge parallel to the first edge, and a fourth edge parallel to the second edge, a second area extending from the first edge and at least a portion of which is bent, a third area extending from the second edge and at least a portion of which is bent, a fourth area extending from the third edge and at least a portion of which is bent, and a fifth area extending from the fourth edge and at least a portion of which is bent.

According to some embodiments, the first sensing area and the second sensing area may overlap the third area.

According to some embodiments, the first sensing area may overlap the third area, and the second sensing area may overlap the fifth area.

According to some embodiments, the first sensing area may overlap the third area, and the second sensing area may overlap the fourth area.

According to some embodiments, the first authentication information may include the first biometric information and information corresponding to the first sensing area.

According to some embodiments, the method may further include allowing a third pixel among the plurality of pixels to emit a light, the third pixel being in a third sensing area of the display area, which overlaps the external input and is different from the first sensing area and the second sensing area, sensing, at a third sensor among the plurality of sensors, third biometric information different from the first biometric information and the second biometric information from the external input, the third sensor being in the third sensing area, and matching the third biometric information with third authentication information different from the stored first authentication information and the second authentication information.

According to some embodiments, a display device may include a display panel in which a display area and a non-display area adjacent to the display area are defined and including a plurality of pixels and a plurality of sensors, an input sensing layer on the display panel and sensing an external input, a drive controller driving the display panel, and a readout circuit electrically connected to the plurality of sensors and outputting a sensing signal to the drive controller. According to some embodiments, the external input may overlap the display area and may define a first sensing area and a second sensing area different from the first sensing area. According to some embodiments, a first sensor in the first sensing area from among the plurality of sensors may sense first biometric information from the external input, the drive controller may compare the first biometric information and stored first authentication information, a second sensor in the second sensing area from among the plurality of sensors may sense second biometric information from the external input, the drive controller may compare the second biometric information and stored second authentication information, and the drive controller drives the display panel when the first biometric information is matched with the first authentication information or when the second biometric information is matched with the second authentication information.

According to some embodiments, the external input may include a hand of a user, and the first biometric information may include a thumb fingerprint of the hand of the user, and the second biometric information may include a palm of the hand of the user.

According to some embodiments, the display may area include a first area including a first edge, a second edge extending in a direction intersecting the first edge, a third edge parallel to the first edge, and a fourth edge parallel to the second edge, a second area extending from the first edge and at least a portion of which is bent, a third area extending from the second edge and at least a portion of which is bent, a fourth area extending from the third edge and at least a portion of which is bent, and a fifth area extending from the fourth edge and at least a portion of which is bent.

According to some embodiments, the first sensing area and the second sensing area may overlap the third area.

According to some embodiments, the first sensing area may overlap the third area, and the second sensing area may overlap the fifth area.

According to some embodiments, the first authentication information may include the first biometric information and information corresponding to the first sensing area.

### BRIEF DESCRIPTION OF THE FIGURES

The above and other aspects and features of embodiments according to the present disclosure will become more apparent by describing in more detail aspects of some embodiments thereof with reference to the accompanying drawings.

FIG. 1 is a perspective view illustrating a display device according to some embodiments of the present disclosure.

FIG. 2 is an exploded perspective view illustrating a display device according to some embodiments of the present disclosure.

FIG. 3 is a cross-sectional view of a display device according to some embodiments of the present disclosure.

FIG. 4 is a block diagram illustrating a display device according to some embodiments of the present disclosure.

FIG. 5 is a block diagram illustrating a part of a display device according to some embodiments of the present disclosure.

FIG. 6 is an enlarged plan view illustrating a partial area of an active area according to some embodiments of the present disclosure.

FIG. 7 is a circuit diagram illustrating a pixel and a sensor according to some embodiments of the present disclosure.

FIG. 8 is a cross-sectional view of a pixel and a sensor of a display panel taken along the line I-I′ of FIG. 7, according to some embodiments of the present disclosure.

FIG. 9 is a flowchart illustrating a method of controlling a display device according to some embodiments of the present disclosure.

FIG. 10 is a conceptual diagram illustrating a user's hand and a display device according to some embodiments of the present disclosure.

FIG. 11 is a conceptual diagram illustrating a user's hand and a display device according to some embodiments of the present disclosure.

FIG. 12 is a conceptual diagram illustrating a user's hand and a display device according to some embodiments of the present disclosure.

### DETAILED DESCRIPTION

In the specification, the expression that a first component (or an area, a layer, a part, or a portion) is “on”, “connected to”, or “coupled to” a second component means that the first component is directly on/connected to/coupled to the second component or means that a third component is interposed therebetween.

The same reference numerals refer to the same components. In addition, in drawings, thicknesses, proportions, and dimensions of components may be exaggerated to describe the technical features effectively. The expression “and/or” includes one or more combinations which associated components are capable of defining.

Although the terms “first”, “second”, etc. may be used to describe various components, the components should not be construed as being limited by the terms. The terms are only used to distinguish one component from another component. For example, without departing from the scope and spirit of the invention, a first component may be referred to as a “second component”, and similarly, the second component may be referred to as the “first component”. The singular forms are intended to include the plural forms unless the context clearly indicates otherwise.

Also, the terms “under”, “below”, “on”, “above”, etc. are used to describe the correlation of components illustrated in drawings. The terms that are relative in concept are described based on a direction shown in drawings.

It will be further understood that the terms “comprises”, “includes”, “have”, etc. specify the presence of stated features, numbers, steps, operations, elements, components, or a combination thereof but do not preclude the presence or addition of one or more other features, numbers, steps, operations, elements, components, or a combination thereof.

Unless otherwise defined, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, aspects of some embodiments of the present disclosure will be described in more detail with reference to drawings.

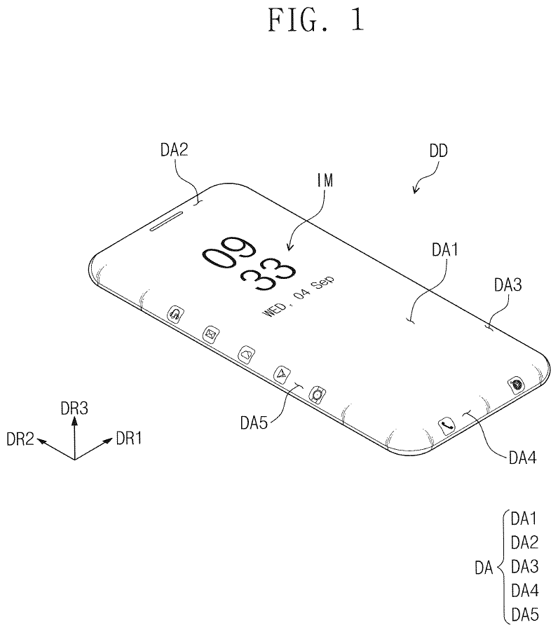

FIG. 1 is a perspective view of a display device according to some embodiments of the present disclosure.

Referring to FIG. 1, a display device DD may be a device which is activated depending on an electrical signal. The display device DD may include various embodiments. For example, the display device DD may include a small and medium-sized electronic device such as a mobile phone, a tablet, an automotive navigation system, a game console, or a smart watch, as well as a large-sized electronic device such as a television or a monitor. Embodiments in which the display device DD is a smartphone is illustrated as an example.

A display area DA may be defined in the display device DD. The display area DA may include a first display area DA1, a second display area DA2, a third display area DA3, a fourth display area DA4, and a fifth display area DA5.

The first display area DA1 may be parallel to a surface which is defined by a first direction DR1 and a second direction DR2. The normal direction of the first display area DA1 may correspond to a thickness direction (hereinafter referred to as a “third direction DR3”) of the display device DD. According to some embodiments, a front surface (or an upper/top surface) and a rear surface (or a lower/bottom surface) of each member may be defined with respect to the third direction DR3. The front surface and the rear surface may be opposite to each other in the third direction DR3. The third direction DR3 may be a direction intersecting a plane defined by the first direction DR1 and the second direction DR2. The first direction DR1, the second direction DR2, and the third direction DR3 may cross at right angles.

Meanwhile, directions which the first direction DR1, the second direction DR2, and the third direction DR3 indicate may be relative in concept and may be changed to different directions. Also, in the specification, the surface defined by the first direction DR1 and the second direction DR2 may be defined as a plane, and the expression “when viewed from above a plane” or “in a plan view” may be defined as “when viewed in the third direction DR3”.

The second display area DA2 may extend from the first side of the first display area DA1. The third display area DA3 may extend from the second side of the first display area DA1. The fourth display area DA4 may extend from the third side of the first display area DA1. The fifth display area DA5 may extend from the fourth side of the first display area DA1.

Each of the second display area DA2, the third display area DA3, the fourth display area DA4, and the fourth display area DA4 may be curved with a given curvature.

In the display device DD, the area of the display area DA, which is recognized by the user, may be increased by the second display area DA2, the third display area DA3, the fourth display area DA4, and the fourth display area DA4 curved with the given curvature.

An image IM may be displayed in the display area DA. A clock window and icons are illustrated in FIG. 1 as an example of the image IM. For example, the clock window may be displayed in the first display area DA1, and the icons may be displayed in some of the second to fifth display areas DA2, DA3, DA4, and DA5.

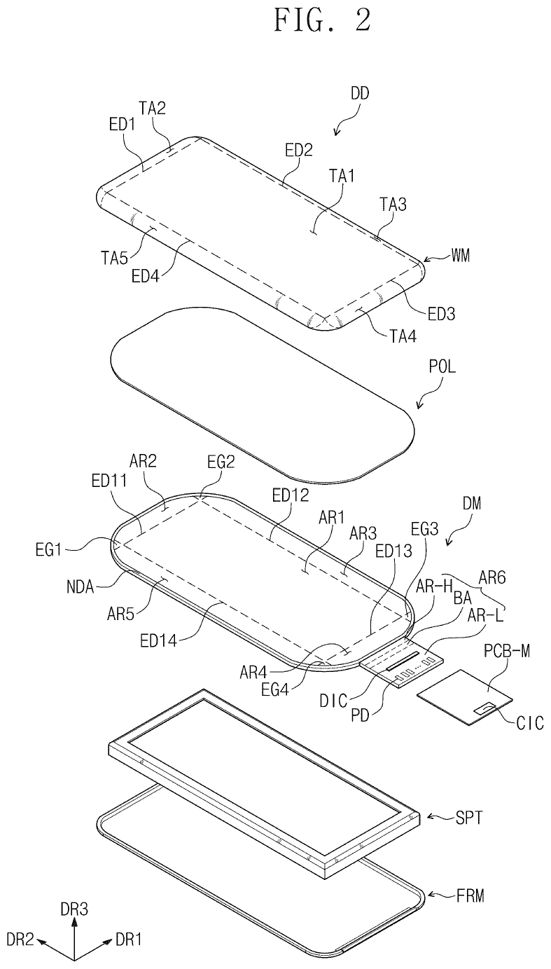

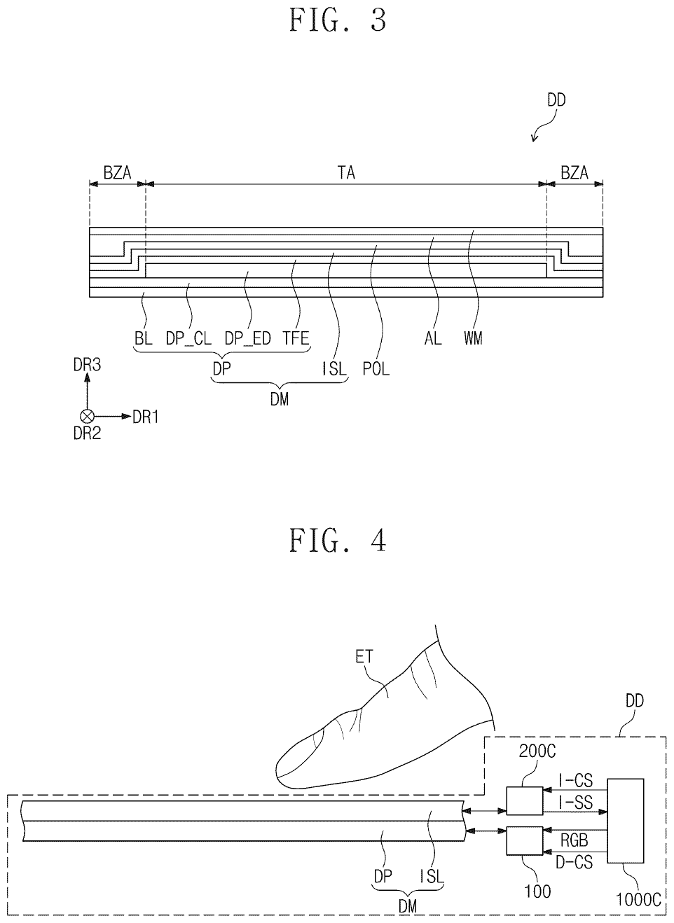

FIG. 2 is an exploded perspective view of a display device according to some embodiments of the present disclosure, and FIG. 3 is a cross-sectional view of a display device according to some embodiments of the present disclosure.

Referring to FIGS. 2 and 3, the display device DD may include a window WM, an optical film POL, a display module DM, a printed circuit board PCB-M, a support member SPT, and a frame FRM.

The window WM may be located on a display panel DP. The window WM may protect the display panel DP from an external impact. The window WM may include a transparent material. For example, the window WM may include glass or transparent synthetic resin or other transparent material (e.g., insulating transparent material).

The window WM may include transmission areas TA1, TA2, TA3, TA4, and TA5. The transmission areas TA1, TA2, TA3, TA4, and TA5 may include the first transmission area TA1, the second transmission area TA2, the third transmission area TA3, the fourth transmission area TA4, and the fifth transmission area TA5.

The first transmission area TA1 may be parallel to the surface defined by the first direction DR1 and the second direction DR2. The first transmission area TA1 may include a first edge ED1 extending in a direction parallel to the first direction DR1, a second edge ED2 extending from the first edge ED1 in a direction parallel to the second direction DR2, a third edge ED3 extending from the second edge ED2 in a direction parallel to the first direction DR1, and a fourth edge ED4 extending from the third edge ED3 in a direction parallel to the second direction DR2. The first edge ED1 and the third edge ED3 may be parallel to each other, and the second edge ED2 and the fourth edge ED4 may be parallel to each other.

The second transmission area TA2 may extend from the first edge ED1 of the first transmission area TA1. The third transmission area TA3 may extend from the second edge ED2 of the first transmission area TA1. The fourth transmission area TA4 may extend from the third edge ED3 of the first transmission area TA1. The fifth transmission area TA5 may extend from the fourth edge ED4 of the first transmission area TA1.

At least a portion of each of the second transmission area TA2, the third transmission area TA3, the fourth transmission area TA4, and the fifth transmission area TA5 may be bent with a given curvature.

The optical film POL may be located between the window WM and the display module DM. For example, the optical film POL may be a polarization film. The polarization film may reduce the reflectance of an external light incident through the window WM. The optical film POL may include a plurality of color filters and a black matrix and may be located on an input sensing layer ISL.

The display module DM may be a component which generates the image IM (refer to FIG. 1).

A first area AR1, a second area AR2, a third area AR3, a fourth area AR4, a fifth area AR5, and a sixth area AR6 may be defined in the display module DM.

The first area AR1 may be parallel to the surface defined by the first direction DR1 and the second direction DR2. The first area AR1 may include a first edge ED11 extending in a direction parallel to the first direction DR1, a second edge ED12 extending in a direction parallel to the second direction DR2, a third edge ED13 extending in a direction parallel to the first direction DR1, and a fourth edge ED14 extending in a direction parallel to the second direction DR2. The first edge ED11 and the third edge ED13 may be parallel to each other, and the second edge ED12 and the fourth edge ED14 may be parallel to each other.

The second area AR2 may extend from the first edge ED11 of the first area AR1. The third area AR3 may extend from the second edge ED12 of the first area AR1. The fourth area AR4 may extend from the third edge ED13 of the first area AR1. The fifth area AR5 may extend from the fourth edge ED14 of the first area AR1.

In a plan view, the first area AR1 may overlap the first transmission area TA1. The second area AR2 may overlap the second transmission area TA2. The third area AR3 may overlap the third transmission area TA3. The fourth area AR4 may overlap the fourth transmission area TA4. The fifth area AR5 may be overlap the fifth transmission area TA5.

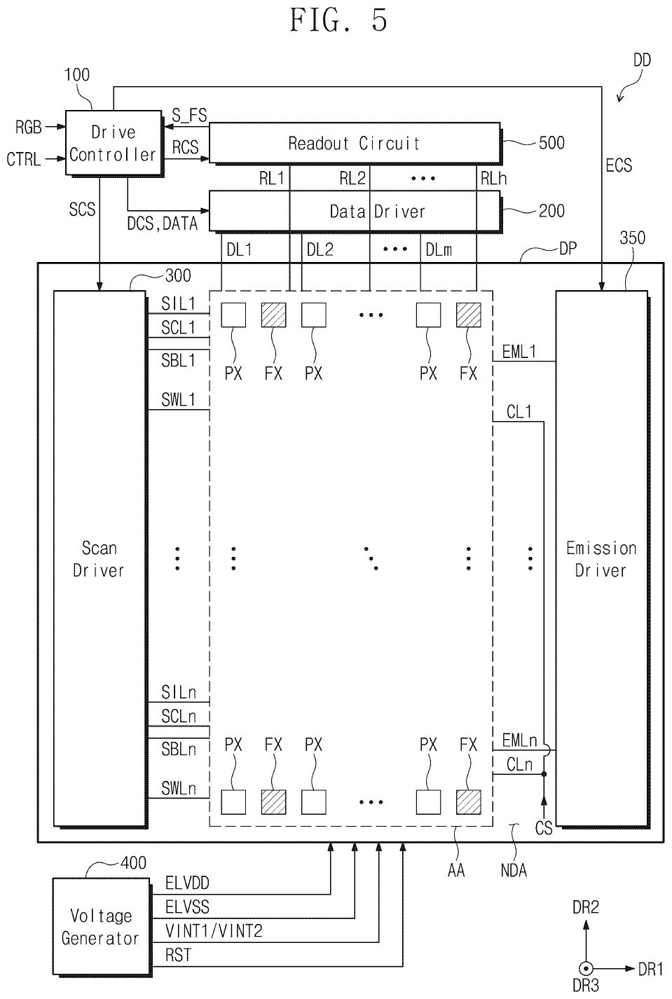

The first area AR1 may display the image IM (refer to FIG. 1) through the first transmission area TA1. The second area AR2 may display the image IM (refer to FIG. 2) through the second transmission area TA2. The third area AR3 may display the image IM (refer to FIG. 3) through the third transmission area TA3. The fourth area AR4 may display the image IM (refer to FIG. 4) through the fourth transmission area TA4. The fifth area AR5 may display the image IM (refer to FIG. 5) through the fifth transmission area TA5.

The second area AR2, the third area AR3, the fourth area AR4, and the fifth area AR5 may be bent with a given curvature so as to correspond to the second transmission area TA2, the third transmission area TA3, the fourth transmission area TA4, and the fifth transmission area TA5, respectively.

In the specification, the first area AR1 may be referred to as the “first display area DA1 (refer to FIG. 1)”. The second area AR2 may be referred to as the “second display area DA2 (refer to FIG. 1)”. The third area AR3 may be referred to as the “third display area DA3 (refer to FIG. 1)”. The fourth area AR4 may be referred to as the “fourth display area DA4 (refer to FIG. 1)”. The fifth area AR5 may be referred to as the “fifth display area DA5 (refer to FIG. 1)”.

A first corner area EG1 may be a surface adjacent to the second area AR2 and the fifth area AR5. The first corner area EG1 may be located between the second area AR2 and the fifth area AR5. The edge of the first corner area EG1 may have a convex shape in a plan view. A second corner area EG2 may be a surface adjacent to the second area AR2 and the third area AR3. The second corner area EG2 may be located between the second area AR2 and the third area AR3. The edge of the second corner area EG2 may have a convex shape in a plan view. A third corner area EG3 may be a surface adjacent to the third area AR3 and the fourth area AR4. The third corner area EG3 may be located between the third area AR3 and the fourth area AR4. The edge of the third corner area EG3 may have a convex shape in a plan view. A fourth corner area EG4 may be a surface adjacent to the fourth area AR4 and the fifth area AR5. The fourth corner area EG4 may be located between the fourth area AR4 and the fifth area AR5. The edge of the fourth corner area EG4 may have a convex shape in a plan view.

The sixth area AR6 may extend from the fourth area AR4 in the second direction DR2. The sixth area AR6 may include an upper area AR-H, a bending area BA, and a lower area AR-L.

The upper area AR-H may extend from the fourth area AR4, the bending area BA may extend from the upper area AR-H, and the lower area AR-L may extend from the bending area BA.

Pads PD may be located in the lower area AR-L, and a data driving circuit DIC may be mounted on the lower area AR-L. The pads PD may be electrically connected to a light emitting layer of the display panel DP. The data driving circuit DIC may provide a data signal to the display area DA (refer to FIG. 1). The display panel DP may be electrically connected to the printed circuit board PCB-M through the pads PD. A control circuit CIC may be mounted on the printed circuit board PCB-M. The control circuit CIC may control the data driving circuit DIC.

A display area TA and a bezel area BZA may be defined in the display module DM. The display area TA may be an area where the images IM (refer to FIG. 1) are displayed. The user visually perceives the images IM through the display area TA. According to some embodiments, the display area TA is illustrated in the shape of a quadrangle whose vertexes are rounded. However, this is illustrated as an example. The display area TA may have various shapes, not limited to the shape illustrated for example in FIG. 1. The display area TA may correspond to the display area DA (refer to FIG. 1) of the display device DD.

The bezel area BZA is adjacent to the display area TA. The bezel area BZA may have a given color. The bezel area BZA may surround the display area TA. As such, the shape of the display area TA may be defined substantially by the bezel area BZA. However, this is illustrated as an example. The bezel area BZA may be only located adjacent to one side of the display area TA or may be omitted.

The display module DM may include the display panel DP and the input sensing layer ISL.

The display panel DP may display the image IM (refer to FIG. 1). The display panel DP according to some embodiments of the present disclosure may be a light emitting display panel, but embodiments according to the present disclosure are not limited thereto. For example, the display panel DP may be an organic light emitting display panel, a quantum dot display panel, a micro-LED display panel, or a nano-LED display panel. A light emitting layer of the organic light emitting display panel may include an organic light emitting material. A light emitting layer of the quantum dot light emitting display panel may include a quantum dot, a quantum rod, etc. A light emitting layer of the micro-LED display panel may include a micro-LED. A light emitting emission layer of the nano-LED display panel may include a nano-LED.

The display panel DP includes a base layer BL, a circuit layer DP_CL, an element layer DP_ED, and an encapsulation layer TFE. The display panel DP according to the present disclosure may be a flexible display panel. However, embodiments according to the present disclosure are not limited thereto. For example, the display panel DP may be a foldable display panel, which is folded about a folding axis, or a rigid display panel.

The base layer BL may include a synthetic resin layer. The synthetic resin layer may be a polyimide-based resin layer, and a material thereof is not specifically limited. Besides, the base layer BL may include a glass substrate, a metal substrate, an organic/inorganic composite material substrate, etc.

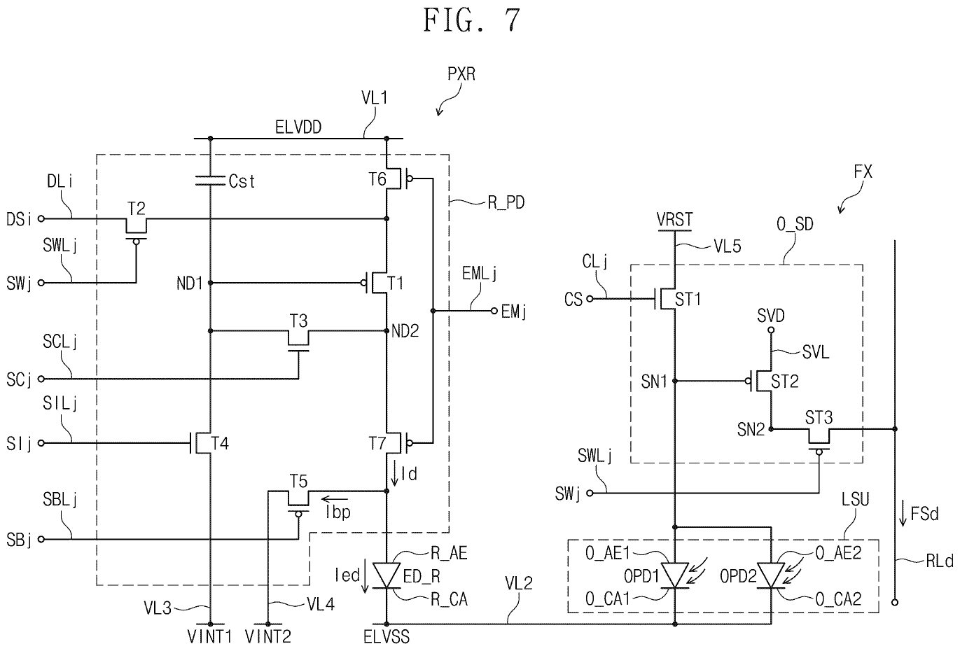

The circuit layer DP_CL is located between the base layer BL and the element layer DP_ED. The circuit layer DP_CL includes at least one insulating layer and a circuit element. Below, the insulating layer included in the circuit layer DP_CL is referred to as an “intermediate insulating layer”. The intermediate insulating layer includes at least one intermediate inorganic film and at least one intermediate organic film. The circuit element may include a pixel driving circuit included in each of a plurality of pixels PX (refer to FIG. 5) for displaying the image IM, and a sensor driving circuit (e.g., O_SD of FIG. 7) included in each of a plurality of sensors FX (refer to FIG. 5) for recognizing external information. The external information may be biometric information. According to some embodiments of the present disclosure, the sensors FX may include a fingerprint recognition sensor, a proximity sensor, an iris recognition sensor, etc. Also, the sensor may include an optical sensor which recognizes biometric information by using an optical method. This will be described in more detail later.

The circuit layer DP_CL may further include signal lines connected to the pixel driving circuit and/or the sensor driving circuit.

The element layer DP_ED may include a light emitting element included in each of the pixels PX and a light sensing element included in each of the sensors FX. According to some embodiments, the light sensing element may be a photodiode. The light sensing element may be a sensor which senses a light reflected by a fingerprint of the user or reacts to a light.

The encapsulation layer TFE seals up the element layer DP_ED. The encapsulation layer TFE may include at least one organic film and at least one inorganic film. The inorganic film may include an inorganic material and may protect the element layer DP_ED from moisture/oxygen. The inorganic film may include a silicon nitride layer, a silicon oxynitride layer, a silicon oxide layer, a titanium oxide layer, an aluminum oxide layer, etc. but is not specially limited thereto. The organic film may include an organic material and may protect the element layer DP_ED from foreign objects such as dust particles.

The input sensing layer ISL may be formed on the display panel DP. The input sensing layer ISL may be directly located on the encapsulation layer TFE. According to some embodiments of the present disclosure, the input sensing layer ISL may be formed on the display panel DP through the same process as the display panel DP. That is, when the input sensing layer ISL is directly located on the display panel DP, an adhesive film is not located between the input sensing layer ISL and the encapsulation layer TFE. Alternatively, an adhesive film may be located between the input sensing layer ISL and the display panel DP. In this case, the input sensing layer ISL may not be manufactured by the same process as the display panel DP. That is, the input sensing layer ISL may be manufactured through a process independent of that of the display panel DP and may then be fixed on an upper surface of the display panel DP by the adhesive film.

The input sensing layer ISL may sense an external input (e.g., a touch of the user), may change the sensed input into a given input signal, and may provide the input signal to the display panel DP. The input sensing layer ISL may include a plurality of sensing electrodes for sensing an external input. The sensing electrodes may sense the external input by using a capacitive method. The display panel DP may receive the input signal from the input sensing layer ISL and may generate an image corresponding to the input signal.

The support member SPT may be located under the display panel DP. The support member SPT may support at least some of components of the display panel DP.

The frame FRM may be located under the support member SPT. The frame FRM may accommodate at least some of the support member SPT, the display panel DP, and the window WM. According to some embodiments of the present disclosure, the frame FRM may be coupled to the window WM.

The display device DD according to some embodiments of the present disclosure may further include an adhesive layer AL. The window WM may be attached to the input sensing layer ISL by the adhesive layer AL. The adhesive layer AL may include an optical clear adhesive, an optically clear adhesive resin, or a pressure sensitive adhesive (PSA).

FIG. 4 is a block diagram illustrating a display device according to some embodiments of the present disclosure. In the description of FIG. 4, the components that are described with reference to FIG. 3 are marked by the same reference numerals/signs, and thus, some additional description may be omitted to avoid redundancy.

Referring to FIG. 4, the display device DD may sense an external input which is applied from the outside. The external input may include various types of inputs which are provided from the outside of the display device DD. For example, as well as a contact by a part of the human body such as the user's hand ET or a contact by a separate device (e.g., a touch pen or an active pen), the external input may include an external input (e.g., hovering) which is applied in a state where the user's hand ET comes close to the display device DD or is adjacent to the display device DD within a given distance. Also, the external input may be provided in various types such as a force type, a pressure type, a temperature type, and a light type.

The display device DD may sense biometric information of the user, which is applied from the outside. A biometric information sensing area capable of sensing the biometric information of the user may be provided in the display device DD. The biometric information sensing area may be provided in the whole area of the display area DA (refer to FIG. 1) or may be provided in a partial area of the display area DA (refer to FIG. 1). As an example of the present disclosure, the whole display area DA may be utilized as the biometric information sensing area.

The display device DD may include the display module DM, a drive controller 100, a sensor driving unit 200C, and a main driving unit 1000C.

The main driving unit 1000C may control an overall operation of the display device DD. For example, the main driving unit 1000C may control operations of the drive controller 100 and the sensor driving unit 200C. The main driving unit 1000C may include at least one microprocessor, and the main driving unit 1000C may be referred to as a “host”.

The drive controller 100 may control the display panel DP. The main driving unit 1000C may further include a graphics controller. The drive controller 100 may receive an image signal RGB and a control signal D-CS from the main driving unit 1000C. The control signal D-CS may include various signals. For example, the control signal D-CS may include an input vertical synchronization signal, an input horizontal synchronization signal, a main clock, a data enable signal, etc. The drive controller 100 may generate a vertical synchronization signal and a horizontal synchronization signal for controlling a timing to provide a signal to the display panel DP, based on the control signal D-CS.

The sensor driving unit 200C may control the input sensing layer ISL. The sensor driving unit 200C may receive a control signal I-CS from the main driving unit 1000C.

The sensor driving unit 200C may calculate coordinates of a first input or a second input based on a signal received from the input sensing layer ISL and may provide a coordinate signal I-SS including information about the coordinates to the main driving unit 1000C. The main driving unit 1000C executes an operation corresponding to the user input based on the coordinate signal I-SS. For example, the main driving unit 1000C may control the drive controller 100 based on the coordinate signal I-SS such that a new application image may be displayed on the display panel DP.

FIG. 5 is a block diagram partially illustrating a display device according to some embodiments of the present disclosure.

Referring to FIG. 5, the display device DD includes the display panel DP, a panel driver, and the drive controller 100. According to some embodiments, the panel driver may include a data driver 200, a scan driver 300, an emission driver 350, a voltage generator 400, and a readout circuit 500.

The drive controller 100 may receive the image signal RGB and an external control signal CTRL. The external control signal CTRL may be substantially the same signal as the control signal D-CS (refer to FIG. 4). The drive controller 100 generates an image data signal DATA by converting a data format of the image signal RGB in compliance with the specification for an interface with the data driver 200. The drive controller 100 may output a gate driving signal SCS, a source driving signal DCS, an emission control signal ECS, and a read control signal RCS based on the external control signal CTRL.

The data driver 200 receives the source driving signal DCS and the image data signal DATA from the drive controller 100. The data driver 200 converts the image data signal DATA into data signals and outputs the data signals to a plurality of data lines DL1 to DLm to be described in more detail later. The data signals are analog voltages corresponding to a grayscale value of the image data signal DATA.

The scan driver 300 receives the gate driving signal SCS from the drive controller 100. The scan driver 300 may output scan signals to a plurality of scan lines to be described later, in response to the gate driving signal SCS.

The voltage generator 400 generates voltages necessary for an operation of the display panel DP. According to some embodiments, the voltage generator 400 generates a first driving voltage ELVDD, a second driving voltage ELVSS, a first initialization voltage VINT1, and a second initialization voltage VINT2. According to some embodiments, the voltage generator 400 may operate under control of the drive controller 100. According to some embodiments, the voltage level of the first driving voltage ELVDD is higher than the voltage level of the second driving voltage ELVSS. According to some embodiments, the voltage level of the first driving voltage ELVDD may be about 3 V to 6 V. The voltage level of the second driving voltage ELVSS may be approximately 0 V to −3 V. The voltage levels of the first and second initialization voltages VINT1 and VINT2 are lower than the voltage level of the second driving voltage ELVSS. According to some embodiments, the voltage level of each of the first and second initialization voltages VINT1 and VINT2 may be about −3.5 V to −6 V. However, the present disclosure is not limited thereto. For example, the voltage levels of the first driving voltage ELVDD, the second driving voltage ELVDD, and the first and second initialization voltages VINT1 and VINT2, which are generated by the voltage generator 400, may vary depending on shapes of the display device DD and the display panel DP.

According to some embodiments, the voltage generator 400 may further generate a reset voltage VRST. According to some embodiments, the voltage level of the reset voltage VRST is lower than the voltage level of the second driving voltage ELVSS. According to some embodiments, the voltage generator 400 may generate the reset voltage VRST as a voltage which is identical to one of the first and second initialization voltages VINT1 and VINT2.

The display panel DP may include a display area AA corresponding to the display area TA (refer to FIG. 3) and a non-display area (or a peripheral area) NDA corresponding to the bezel area BZA (refer to FIG. 3).

The display panel DP may include the plurality of pixels PX located in the display area AA and the plurality of sensors FX located in the display area AA. According to some embodiments, each of the plurality of sensors FX may be located between two adjacent pixels PX. The plurality of pixels PX and the plurality of sensors FX may be alternately arranged on the first and second directions DR1 and DR2. However, the present disclosure is not limited thereto. That is, two or more pixels PX may be located between two sensors FX adjacent to each other on the second direction DR2 from among the plurality of sensors FX, or two or more pixels PX may be located between two sensors FX adjacent to each other on the first direction DR1 from among the plurality of sensors FX.

The display panel DP further includes a plurality of initialization scan lines SIL1 to SILn, a plurality of compensation scan lines SCL1 to SCLn, a plurality of write scan lines SWL1 to SWLn, a plurality of black scan lines SBL1 to SBLn, a plurality of emission control lines EML1 to EMLn, the plurality of data lines DL1 to DLm, a plurality of sensing lines RL1 to RLh, and a plurality of sensing control lines CL1 to CLn. The initialization scan lines SIL1 to SILn, the compensation scan lines SCL1 to SCLn, the write scan lines SWL1 to SWLn, the black scan lines SBL1 to SBLn, the emission control lines EML1 to EMLn, and the sensing control lines CL1 to CLn extend in the first direction DR1. The initialization scan lines SIL1 to SILn, the compensation scan lines SCL1 to SCLn, the write scan lines SWL1 to SWLn, the black scan lines SBL1 to SBLn, the emission control lines EML1 to EMLn, and the sensing control lines CL1 to CLn are arranged to be spaced from each other in the second direction DR2. The data lines DL1 to DLm to the sensing lines RL1 to RLh extend in the second direction DR2 and are arranged to be spaced from each other in the first direction DR1.

The plurality of pixels PX are electrically connected to the initialization scan lines SIL1 to SILn, the compensation scan lines SCL1 to SCLn, the write scan lines SWL1 to SWLn, the black scan lines SBL1 to SBLn, the emission control lines EML1 to EMLn, and the data lines DL1 to DLm. For example, each of the plurality of pixels PX may be electrically connected to four scan lines. However, the number of scan lines connected to each pixel PX is not limited thereto and may be changed.

The plurality of sensors FX are electrically connected to the sensing control lines CL1 to CLn, the write scan lines SWL1 to SWLn, and the sensing lines RL1 to RLh. However, embodiments according to the present disclosure are not limited thereto. The number of lines connected to each sensor FX may be variable. According to some embodiments, the number of sensing lines RL1 to RLh may correspond to ½ of the number of data lines DL1 to DLm. However, embodiments according to the present disclosure are not limited thereto. Alternatively, the number of sensing lines RL1 to RLh may correspond to ¼ or ⅛ of the number of data lines DL1 to DLm. The number of sensing control lines CL1 to CLn may correspond to the number of write scan lines SWL1 to SWLn. However, embodiments according to the present disclosure are not limited thereto. Alternatively, the number of sensing control lines CL1 to CLn may correspond to ½, ¼, or ⅛ of the number of write scan lines SWL1 to SWLn. The scan driver 300 may be located in the non-display area NDA of the display panel DP. The scan driver 300 receives the gate driving signal SCS from the drive controller 100. In response to the gate driving signal SCS, the scan driver 300 outputs initialization scan signals to the initialization scan lines SIL1 to SILn and outputs compensation scan signals to the compensation scan lines SCL1 to SCLn. According to some embodiments, the scan driver 300 may sequentially supply the initialization scan signals to the initialization scan lines SIL1 to SILn and may sequentially supply the compensation scan signals to the compensation scan lines SCL1 to SCLn. Also, in response to the gate driving signal SCS, the scan driver 300 may output write scan signals to the write scan lines SWL1 to SWLn and may output black scan signals to the black scan lines SBL1 to SBLn. According to some embodiments, the scan driver 300 may sequentially supply the write scan signals to the write scan lines SWL1 to SWLn and may sequentially supply the black scan signals to the black scan lines SBL1 to SBLn.

Alternatively, the scan driver 300 may include a first scan driver and a second scan driver. The first scan driver may output the initialization scan signals and the compensation scan signals, and the second scan driver may output the write scan signals and the black scan signals.

According to some embodiments, a sensing control signals CS may be supplied to the sensing control lines CL1 to CLn at the same time. According to some embodiments, the display device DD may further include a sensing control unit which generates the sensing control signal CS. Also, alternatively, the scan driver 300 may provide the sensing control signal CS to the sensing control lines CL1 to CLn. In this case, the sensing control unit may be included in the scan driver 300.

The emission driver 350 may be located in the non-display area NDA of the display panel DP. The emission driver 350 receives the emission control signal ECS from the drive controller 100. The emission driver 350 may output emission control signals to the emission control lines EML1 to EMLn in response to the emission control signal ECS. Alternatively, the scan driver 300 may be connected to the emission control lines EML1 to EMLn. In this case, the emission driver 350 may be omitted, and the scan driver 300 may output the emission control signals to the emission control lines EML1 to EMLn.

The readout circuit 500 receives the read control signal RCS from the drive controller 100. The readout circuit 500 may receive sensing signals from the sensing lines RL1 to RLh in response to the read control signal RCS. The readout circuit 500 may process the sensing signals received from the sensing lines RL1 to RLh may provide processed sensing signals S_FS to the drive controller 100. The drive controller 100 may recognize biometric information based on the processed sensing signals S_FS.

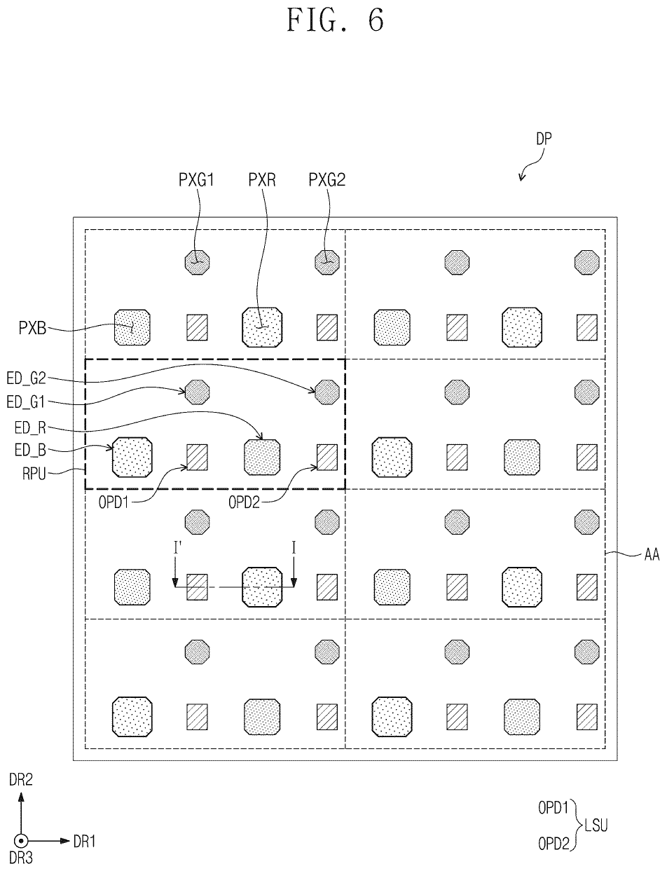

FIG. 6 is an enlarged plan view illustrating a partial area of a display area according to some embodiments of the present disclosure.

Referring to FIGS. 5 and 6, the display panel DP includes the plurality of pixels PX and the plurality of sensors FX.

The plurality of pixels PX may be grouped into a plurality of reference pixel units RPU. According to some embodiments, each reference pixel unit RPU may include four pixels, that is, a first pixel PXR (hereinafter referred to as a “red pixel”), two second pixels PXG1 and PXG2 (hereinafter referred to as “first and second green pixels”), and a third pixel PXB (hereinafter referred to as a “blue pixel”). However, the number of pixels included in each reference pixel unit RPU is not limited thereto. Alternatively, each reference pixel unit RPU may include three pixels, that is, the red pixel PXR, the first green pixel PXG1 (or the second green pixel PXG2), and the blue pixel PXB.

The red pixel PXR includes a first light emitting element ED_R (hereinafter referred to as a “red light emitting element”), the first green pixel PXG1 includes a second light emitting element ED_G1 (hereinafter referred to as a “first green light emitting element”), the second green pixel PXG2 includes a second light emitting element ED_G2 (hereinafter referred to as a “second green light emitting element”), and the blue pixel PXB includes a third light emitting element ED_B (hereinafter referred to as a “blue light emitting element”). According to some embodiments, the red light emitting element ED_R outputs a first color light (e.g., a red light), each of the first and second green light emitting elements ED_G1 and ED_G2 outputs a second color light (e.g., a green light), and the blue light emitting element ED_B outputs a third color light (e.g., a blue light).

The red light emitting element ED_R and the blue light emitting element ED_B may be arranged repeatedly and alternately on the first direction DR1 and the second direction DR2. The first green light emitting elements ED_G1 may be arranged along the second direction DR2, and the second green light emitting elements ED_G2 may be arranged along the second direction DR2. The first green light emitting elements ED_G1 and the second green light emitting elements ED_G2 may be arranged in different columns. The first and second green light emitting elements ED_G1 and ED_G2 may be arranged alternately along the first direction DR1. On the first and second directions DR1 and DR2, the first and second green light emitting elements ED_G1 and ED_G2 may be arranged at rows and columns different from rows and columns on which the red light emitting elements ED_R and the blue light emitting elements ED_B are located.

According to some embodiments, the red light emitting element ED_R may be larger in size than the first and second green light emitting elements ED_G1 and ED_G2. Also, the blue light emitting element ED_B may be larger in size than the red light emitting element ED_R or may be identical in size to the red light emitting element ED_R. The size of each of the light emitting elements ED_R, ED_G1, ED_G2, and ED_B is not limited thereto, and may be variously modified. For example, according to some embodiments of the present disclosure, the light emitting elements ED_R, ED_G1, ED_G2, and ED_B may have the same size.

The first and second green light emitting elements ED_G1 and ED_G2 may have the same shape as the red and blue light emitting elements ED_R and ED_B. According to some embodiments, each of the red and blue light emitting elements ED_R and ED_B may be in the shape of an octagon where a length in the first direction DR1 and a length in the second direction DR2 are identical to each other. That is, the red and blue light emitting elements ED_R and ED_B may have the same size or different sizes but may have the same shape.

Each of the first and second green light emitting elements ED_G1 and ED_G2 may be in the shape of an octagon where a length in the first direction DR1 and a length in the second direction DR2 are identical to each other. According to some embodiments, the first and second green light emitting elements ED_G1 and ED_G2 have the same size and the same shape. However, the shapes of the light emitting elements ED_R, ED_G1, ED_G2, and ED_B are not limited thereto. The shape of each of the light emitting elements ED_R, ED_G1, ED_G2, and ED_B may be variously changed and modified. According to some embodiments, each of the light emitting elements ED_R, ED_G1, ED_G2, and ED_B may be in the shape of a circle, a rectangle, or a diamond.

Each of the plurality of sensors FX includes a light sensing unit LSU. The light sensing unit LSU includes “k” light sensing elements. In this case, “k” is a natural number of 1 or more. According to some embodiments, the light sensing unit LSU is illustrated in FIG. 6 as including two light sensing elements (hereinafter referred to as “first and second light sensing elements OPD1 and OPD2”), but the present disclosure is not limited thereto. For example, the light sensing unit LSU may include one light sensing element or three or more light sensing elements.

According to some embodiments, each reference pixel unit RPU includes the first and second light sensing elements OPD1 and OPD2. However, the number of light sensing elements included in each reference pixel unit RPU is not limited thereto. For example, each reference pixel unit RPU may include one light sensing element or three or more light sensing elements.

Each of the first and second light sensing elements OPD1 and OPD2 may be located between the red light emitting element ED_R and the blue light emitting element ED_B on the first direction DR1. Each of the first and second light sensing elements OPD1 and OPD2 may be located adjacent to the first green light emitting element ED_G1 or the second green light emitting element ED_G2 on the second direction DR2. According to some embodiments, the first light sensing element OPD1 is located between two first green light emitting elements ED_G1 adjacent to each other on the second direction DR2. The second light sensing element OPD2 is located between two second green light emitting elements ED_G2 adjacent to each other on the second direction DR2.

The first and second light sensing elements OPD1 and OPD2 may have the same size and the same shape. Each of the first and second light sensing elements OPD1 and OPD2 may be smaller in size than the red and blue light emitting elements ED_R and ED_B. According to some embodiments, the size of each of the first and second light sensing elements OPD1 and OPD2 may be identical or similar to that of the first and second green light emitting elements ED_G1 and ED_G2. However, the size of each of the first and second light sensing elements OPD1 and OPD2 is not limited thereto, and may be variously modified and applied. Each of the first and second light sensing elements OPD1 and OPD2 may be different in shape from the red and blue light emitting elements ED_R and ED_B. According to some embodiments, each of the first and second light sensing elements OPD1 and OPD2 may be in the shape of a rectangle. Each of the first and second light sensing elements OPD1 and OPD2 may be in the shape of a rectangle where a length in the second direction DR2 is longer than a length in the first direction DR1. Alternatively, each of the first and second light sensing elements OPD1 and OPD2 may be in the shape of a square where a length in the first direction DR1 is identical to a length in the second direction DR2.

FIG. 7 is a circuit diagram illustrating a pixel and a sensor according to some embodiments of the present disclosure. Although various components are illustrated in FIG. 7, embodiments according to the present disclosure are not limited thereto. For example, various embodiments may include additional components or fewer components without departing from the spirit and scope of embodiments according to the present disclosure.

An equivalent circuit diagram of one pixel (e.g., the red pixel PXR) among the plurality of pixels PX (refer to FIG. 5) illustrated in FIG. 5 is illustrated in FIG. 7 as an example. Below, a circuit structure of the red pixel PXR will be described. Because the plurality of pixels PX (refer to FIG. 5) have the same circuit structure, additional description associated with the remaining pixels will be omitted to avoid redundancy. Also, an equivalent circuit diagram of one sensor FX (refer to FIG. 5) among the plurality of sensors FX (refer to FIG. 5) illustrated in FIG. 5 is illustrated in FIG. 7 as an example. Below, a circuit structure of the sensor FX (refer to FIG. 5) will be described. Because the plurality of sensors FX have the same structure, additional description associated with the remaining sensors will be omitted to avoid redundancy.

Referring to FIGS. 5 and 7, the red pixel PXR is connected to the i-th data line DLi among the data lines DL1 to DLm, the j-th initialization scan line SILj among the initialization scan lines SIL1 to SILn, the j-th compensation scan line SCLj among the compensation scan lines SCL1 to SCLn, the j-th write scan line SWLj among the write scan lines SWL1 to SWLn, the j-th black scan line SBLj among the black scan lines SBL1 to SBLn, and the j-th emission control line EMLj of the emission control lines EML1 to EMLn.

The red pixel PXR include the red light emitting element ED_R and a red pixel driving circuit R_PD. The red light emitting element ED_R may be a light emitting diode. According to some embodiments, the red light emitting element ED_R may include an organic light emitting diode including an organic light emitting layer.

The red pixel driving circuit R_PD includes first to seventh transistors T1, T2, T3, T4, T5, T6, and T7 and one capacitor Cst. At least one of the first to seventh transistors T1, T2, T3, T4, T5, T6, or T7 may be a transistor having a low-temperature polycrystalline silicon (LTPS) semiconductor layer. At least one of the first to seventh transistors T1, T2, T3, T4, T5, T6, or T7 may be a transistor having an oxide semiconductor layer. Some of the first to seventh transistors T1 to T7 may be P-type transistors, and the remaining transistors may be N-type transistors. For example, the first, second, fifth, sixth, and seventh transistors T1, T2, T5, T6, and T7 are PMOS transistors, and the third and fourth transistors T3 and T4 may be NMOS transistors. For example, the third and fourth transistors T3 and T4 may be oxide semiconductor transistors, and the first, second, fifth, sixth, and seventh transistors T1, T2, T5, T6, and T7 may be LTPS transistors.

A configuration of the red pixel driving circuit R_PD according to the present disclosure is not limited to the embodiments illustrated and described with respect to FIG. 7. The red pixel driving circuit R_PD illustrated in FIG. 7 is only an example, and the configuration of the red pixel driving circuit R_PD may be modified and implemented. For example, all of the first to seventh transistors T1 to T7 may be P-type transistors or N-type transistors.

The j-th initialization scan line SILj, the j-th compensation scan line SCLj, the j-th write scan line SWLj, the j-th black scan line SBLj, and the j-th emission control line EMLj may transfer a j-th initialization scan signal Slj, a j-th compensation scan signal SCj, a j-th write scan signal SWj, a j-th black scan signal SBj, and a j-th emission control signal EMj to the red pixel PXR, respectively. The i-th data line DLi transfers an i-th data signal Di to the red pixel PXR. The i-th data signal Di may have a voltage level corresponding to the image signal RGB (refer to FIG. 4) input to the display device DD (refer to FIG. 4).

First and second driving voltage lines VL1 and VL2 may respectively transfer the first and second driving voltages ELVDD and ELVSS to the red pixel PXR. Also, first and second initialization voltage lines VL3 and VL4 may respectively transfer the first and second initialization voltages VINT1 and VINT2 to the red pixel PXR.

The first transistor T1 is connected between the first driving voltage line VL1 receiving the first driving voltage ELVDD and the red light emitting element ED_R. The first transistor T1 includes a first electrode connected to the first driving voltage line VL1 through the sixth transistor T6, a second electrode connected to a red anode electrode R_AE of the red light emitting element ED_R through the seventh transistor T7, and a third electrode connected to a first electrode end of the capacitor Cst (e.g., to a first node ND1). The first transistor T1 may receive the i-th data signal Di transferred through the i-th data line DLi depending on a switching operation of the second transistor T2 and may then supply a driving current Id to the red light emitting element ED_R. According to some embodiments, the first transistor T1 may be referred to as a “driving transistor”.

The second transistor T2 is connected between the i-th data line DLi and the first electrode of the first transistor T1. The second transistor T2 includes a first electrode connected to the i-th data line DLi, a second electrode connected to the first electrode of the first transistor T1, and a third electrode connected to the j-th write scan line SWLj. The second transistor T2 may be turned on depending on the j-th write scan signal SWj transferred through the j-th write scan line SWLj and may transfer the i-th data signal Di transferred from the i-th data line DLi to the first electrode of the first transistor T1. According to some embodiments, the second transistor T2 may be referred to as a “switching transistor”.

The third transistor T3 is connected between the second electrode of the first transistor T1 and the first node ND1. The third transistor T3 includes a first electrode connected to the third electrode of the first transistor T1, a second electrode connected to the second electrode of the first transistor T1, and a third electrode connected to the j-th compensation scan line SCLj. The third transistor T3 may be turned on depending on the j-th compensation scan signal SCj transferred through the j-th compensation scan line SCLj and may connect the third electrode and the second electrode of the first transistor T1. In this case, the first transistor T1 may be diode-connected. According to some embodiments, the third transistor T3 may be referred to as a “compensation transistor”.

The fourth transistor T4 is connected between the first initialization voltage line VL3 to which the first initialization voltage VINT1 is applied and the first node ND1. The fourth transistor T4 includes a first electrode connected to the first initialization voltage line VL3, a second electrode connected to the first node ND1, and a third electrode connected to the j-th initialization scan line SILj. The fourth transistor T4 is turned on depending on the j-th initialization scan signal Slj transferred through the j-th initialization scan line SILj. The fourth transistor T4 thus turned on transfers the first initialization voltage VINT1 to the first node ND1 such that a potential of the third electrode of the first transistor T1 (i.e., a potential of the first node ND1) is initialized. According to some embodiments, the fourth transistor T4 may be referred to as an “initialization transistor”.

The sixth transistor T6 includes a first electrode connected to the first driving voltage line VL1, a second electrode connected to the first electrode of the first transistor T1, and a third electrode connected to the j-th emission control line EMLj.

The seventh transistor T7 includes a first electrode connected to the second electrode of the first transistor T1, a second electrode connected to the red anode electrode R_AE of the red light emitting element ED_R, and a third electrode connected to the j-th emission control line EMLj.

The sixth and seventh transistors T6 and T7 are simultaneously turned on depending on the j-th emission control signal EMj transferred through the j-th emission control line EMLj. The first driving voltage ELVDD applied through the sixth transistor T6 thus turned on may be compensated for through the diode-connected transistor T1 and may then be transferred to the red light emitting element ED_R. According to some embodiments, the sixth and seventh transistors T6 and T7 may be referred to an “emission transistor”.

The fifth transistor T5 includes a first electrode connected to the second initialization voltage line VL4 through which the second initialization voltage VINT2 is transferred, a second electrode connected to the second electrode of the seventh transistor T7, and a third electrode connected to the j-th black scan line SBLj. The voltage level of the second initialization voltage VINT2 may lower than or equal to that of the first initialization voltage VINT1. As an example of the present disclosure, the fifth transistor T5 may be referred to as a “black scan transistor”.

The first end of the capacitor Cst is connected to the third electrode of the first transistor T1 as described above, and a second end of the capacitor Cst is connected to the first driving voltage line VL1.

A red cathode electrode R_CA of the red light emitting element ED_R may be connected to the second driving voltage line VL2 transferring the second driving voltage ELVSS. The voltage level of the second driving voltage ELVSS may be lower than the voltage level of the first driving voltage ELVDD. According to some embodiments, the second driving voltage ELVSS may be lower in level than the first and second initialization voltages VINT1 and VINT2.

The sensor FX is connected to the d-th sensing line RLd among the sensing lines RL1 to RLh, the j-th write scan line SWLj, and the j-th sensing control line CLj.

The sensor FX includes the light sensing unit LSU and the sensor driving circuit O_SD. The light sensing unit LSU may include “k” light sensing elements connected in parallel. When “k” is 2, two light sensing elements (i.e., the first and second light sensing elements OPD1 and OPD2) may be connected in parallel in the sensor driving circuit O_SD. Each of the first and second light sensing elements OPD1 and OPD2 may be a photodiode. According to some embodiments, each of the first and second light sensing elements OPD1 and OPD2 may be an organic photodiode including an organic material as a photoelectric conversion layer. First and second sub-anode electrodes O_AE1 and O_AE2 of the first and second light sensing elements OPD1 and OPD2 may be connected to a first sensing node SN1, and first and second sub-cathode electrodes O_CA1 and O_CA2 of the first and second light sensing elements OPD1 and OPD2 may be connected to the second driving voltage line VL2 transferring the second driving voltage ELVSS.

The sensor driving circuit O_SD includes three transistors ST1 to ST3. The three transistors ST1 to ST3 may be the reset transistor ST1, the amplification transistor ST2, and the output transistor ST3, respectively. At least one of the reset transistor ST1, the amplification transistor ST2, or the output transistor ST3 may be an oxide semiconductor transistor. According to some embodiments, the reset transistor ST1 may be an oxide semiconductor transistor, and the amplification transistor ST2 and the output transistor ST3 may be LTPS transistors. However, the present disclosure is not limited thereto. For example, at least the reset transistor ST1 and the output transistor ST3 may be oxide semiconductor transistors, and the amplification transistor ST2 may be an LTPS semiconductor transistor.

Also, some of the reset transistor ST1, the amplification transistor ST2, and the output transistor ST3 may be P-type transistors, and the other(s) thereof may be an N-type transistor. According to some embodiments, the amplification transistor ST2 and the output transistor ST3 may be PMOS transistors, and the reset transistor ST1 may be an NMOS transistor. However, embodiments according to the present disclosure are not limited thereto. For example, all of the transistors ST1, ST2, and ST3 may be N-type transistors or P-type transistors.

Some (e.g., the reset transistor ST1) of the reset transistor ST1, the amplification transistor ST2, and the output transistor ST3 may be implemented with a transistor whose type is identical to that of the third and fourth transistors T3 and T4 of the red pixel PXR. The amplification transistor ST2 and the output transistor ST3 may be implemented with a transistor whose type is identical to that of the first, second, fifth, sixth, and seventh transistors T1, T2, T5, T6, and T7 of the red pixel PXR.

The circuit configuration of the sensor driving circuit O_SD according to the present disclosure is not limited to FIG. 7. The sensor driving circuit O_SD illustrated in FIG. 7 is provided only as an example, and the configuration of the sensor driving circuit O_SD may be modified and implemented.

The reset transistor ST1 includes a first electrode connected to a reset reception line VL5 receiving the reset voltage VRST, a second electrode connected to the first sensing node SN1, and a third electrode connected to the j-th sensing control line CLj receiving the sensing control signal CS. The reset transistor ST1 may reset a potential of the first sensing node SN1 to the reset voltage VRST in response to the sensing control signal CS.

According to some embodiments, the reset voltage VRST may be a DC voltage which is maintained at a voltage level lower than that of the second driving voltage ELVSS. However, the present disclosure is not limited thereto. The reset voltage VRST may have a voltage level lower than that of the second driving voltage ELVSS during at least an active period of the sensing control signal CS.

The reset transistor ST1 may include a plurality of sub-reset transistors connected in series. For example, the reset transistor ST1 may include two sub-reset transistors (hereinafter referred to as “first and second sub-reset transistors”). In this case, a third electrode of the first sub-reset transistor and a third electrode of the second sub-reset transistor are connected to the j-th sensing control line CLj. Also, a second electrode of the first sub-reset transistor and a first electrode of the second sub-reset transistor may be electrically connected to each other. Also, the reset voltage VRST may be applied to a first electrode of the first sub-reset transistor, and a second electrode of the second sub-reset transistor may be electrically connected to the first sensing node SN1. However, the number of sub-reset transistors is not limited thereto and may be variously changed or modified.

The amplification transistor ST2 includes a first electrode connected to a sensing driving line SVL receiving a sensing driving voltage SVD, a second electrode connected to a second sensing node SN2, and a third electrode connected to the first sensing node SN1. The amplification transistor ST2 may be turned on depending on a potential of the first sensing node SN1 and may apply the sensing driving voltage SVD to the second sensing node SN2. According to some embodiments, the sensing driving voltage SVD may correspond to one of the first driving voltage ELVDD and the first and second initialization voltages VINT1 and VINT2. When the sensing driving voltage SVD corresponds to the first driving voltage ELVDD, the sensing driving line SVL may be electrically connected to the first driving voltage line VL1. When the sensing driving voltage SVD corresponds to the first initialization voltage VINT1, the sensing driving line SVL may be electrically connected to the first initialization voltage line VL3; when the sensing driving voltage SVD corresponds to the second initialization voltage VINT2, the sensing driving line SVL may be electrically connected to the second initialization voltage line VL4.

The output transistor ST3 includes a first electrode connected to the second sensing node SN2, a second electrode connected to the d-th sensing line RLd, and a third electrode connected to an output control line receiving an output control signal. The output transistor ST3 may transfer a d-th sensing signal FSd to the d-th sensing line RLd in response to the output control signal. The output control signal may be the j-th write scan signal SWj which is supplied through the j-th write scan line SWLj. That is, the output transistor ST3 may receive the j-th write scan signal SWj supplied from the j-th write scan line SWLj as the output control signal.

The light sensing unit LSU of the sensor FX may be exposed to a light during a light emitting period of the light emitting elements ED_R, ED_G1, ED_G2, and ED_B (refer to FIG. 6). The light may be a signal output from one of the light emitting elements ED_R, ED_G1, ED_G2, and ED_B (refer to FIG. 6).

When the user's hand ET (refer to FIG. 4) touches the display device DD (refer to FIG. 1), the first and second light sensing elements OPD1 and OPD2 may generate photoelectrons, the amount of which corresponds to the light reflected by a ridge of a fingerprint of the user's hand ET (refer to FIG. 4) or by a valley of ridges thereof, and the generated photoelectrons may be accumulated at the first sensing node SN1.

The d-th sensing signal FSd which is transferred from the sensing driving line SVL to the d-th sensing line RLd through the amplification transistor ST2 and the output transistor ST3 when the output transistor ST3 is turned on is determined by the amount of charges of the first sensing node SN1. According to some embodiments, assuming that the output transistor ST3 is a P-type transistor, as the amount of photoelectrons which are generated by the first and second light sensing elements OPD1 and OPD2 and are then accumulated at the first sensing node SN1 increases, the magnitude of the d-th sensing signal FSd may decrease.

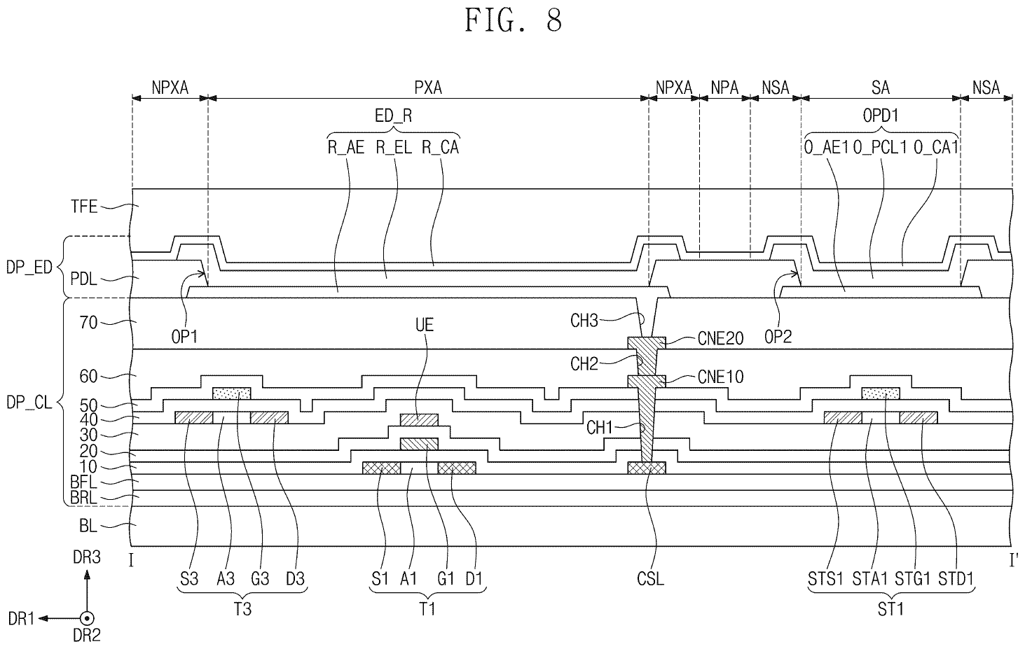

FIG. 8 is a cross-sectional view of a pixel and a sensor of a display panel taken along the line I-I′ of FIG. 6, according to some embodiments of the present disclosure. In the description of FIG. 8, the components that are described with reference to FIG. 3 are marked by the same reference numerals/signs, and thus, some additional description may be omitted to avoid redundancy. Although various operations are illustrated in FIG. 8, embodiments according to the present disclosure are not limited thereto. For example, various embodiments may include additional operations or fewer operations, or the order of operations may vary, unless otherwise explicitly stated or implied, without departing from the spirit and scope of embodiments according to the present disclosure.

Referring to FIG. 8, the display panel DP may include the base layer BL, the circuit layer DP_CL located on the base layer BL, the element layer DP_ED, and the encapsulation layer TFE.

The base layer BL may include a synthetic resin layer. The synthetic resin layer may include thermosetting resin. In particular, the synthetic resin layer may be a polyimide-based resin layer, and a material thereof is not specifically limited. The synthetic resin layer may include at least one of acrylic resin, methacrylic resin, polyisoprene, vinyl resin, epoxy resin, urethane resin, cellulose resin, siloxane resin, polyamide resin, or perylene resin. In addition, the base layer BL may include a glass substrate, a metal substrate, an organic/inorganic composite substrate, etc.

At least one inorganic layer is formed on an upper surface of the base layer BL. The inorganic layer may include at least one of aluminum oxide, titanium oxide, silicon oxide silicon oxynitride, zirconium oxide, or hafnium oxide. The inorganic layer may be formed of multiple layers. The multiple inorganic layers may constitute a barrier layer BRL and/or a buffer layer BFL, which will be described in more detail later. The barrier layer BRL and the buffer layer BFL may be arranged selectively.

The barrier layer BRL prevents foreign objects from being introduced from the outside. The barrier layer BRL may include a silicon oxide layer and a silicon nitride layer. Each of the silicon oxide layer and the silicon nitride layer may be provided in plurality, and the plurality of silicon oxide layers and the plurality of silicon nitride layers may be alternately stacked.

The buffer layer BFL may be located on the barrier layer BRL. The buffer layer BFL relatively improves a bonding force between the base layer BL and a semiconductor pattern and/or a conductive pattern. The buffer layer BFL may include a silicon oxide layer and a silicon nitride layer. The silicon oxide layer and the silicon nitride layer may be alternately stacked.

A semiconductor pattern of the red pixel PXR may be located on the buffer layer BFL. The semiconductor pattern may include a silicon semiconductor. The semiconductor pattern may include polysilicon. However, the present disclosure is not limited thereto. For example, the semiconductor pattern may include amorphous silicon.

An electrical property of the semiconductor pattern varies depending on whether it is doped or not. The semiconductor pattern may include a doped area and an undoped area. The doped area may be doped with the N-type dopant or the P-type dopant. A P-type transistor includes a doped area doped with the P-type dopant, and an N-type transistor includes a doped area doped with the N-type dopant.

The doped area has higher conductivity than the undoped area, and substantially operates as an electrode or a signal line. The undoped area substantially corresponds to the active (or channel) of a transistor.

A first electrode S1, a channel part A1, and a second electrode D1 of the first transistor T1 are formed from the first semiconductor pattern. The first electrode S1 and the second electrode D1 of the first transistor T1 extend in opposite directions from the channel part A1.

A portion of a connection signal line CSL formed from the semiconductor pattern is illustrated in FIG. 8. According to some embodiments, the connection signal line CSL may be electrically connected to the second electrode of the seventh transistor T7 (refer to FIG. 7) on a plane.

A first insulating layer 10 is located on the buffer layer BFL. The first insulating layer 10 overlaps the plurality of pixels PX (refer to FIG. 5) in common and covers the semiconductor pattern. The first insulating layer 10 may be an inorganic layer and/or an organic layer and may have a single-layer or multi-layer structure. The first insulating layer 10 may include at least one of aluminum oxide, titanium oxide, silicon oxide, silicon oxynitride, zirconium oxide, or hafnium oxide. According to some embodiments, the first insulating layer 10 may be a single silicon oxide layer. As well as the first insulating layer 10, an insulating layer of the circuit layer DP_CL to be described later may be an inorganic layer and/or an organic layer and may have a single-layer structure or a multi-layer structure. The inorganic layer may include at least one of the materials described above.

A third electrode G1 of the first transistor T1 is located on the first insulating layer 10. The third electrode G1 may be a portion of a metal pattern. The third electrode G1 of the first transistor T1 overlaps the channel part A1 of the first transistor T1. The third electrode G1 of the first transistor T1 may serve as a mask in the process of doping the semiconductor pattern.

A second insulating layer 20 covering the third electrode G1 is located on the first insulating layer 10. The second insulating layer 20 overlaps the plurality of pixels PX in common. The second insulating layer 20 may be an inorganic layer and/or an organic layer and may have a single-layer or multi-layer structure. According to some embodiments, the second insulating layer 20 may be a single silicon oxide layer.

An upper electrode UE may be located on the second insulating layer 20. The upper electrode UE may overlap the third electrode G1. The upper electrode UE may be a portion of a metal pattern or a portion of a doped semiconductor pattern. A portion of the third electrode G1 and the upper electrode UE overlapping the portion of the third electrode G1 may define the capacitor Cst (refer to FIG. 7). According to some embodiments of the present disclosure, the upper electrode UE may be omitted.

According to some embodiments of the present disclosure, the second insulating layer 20 may be replaced with an insulating pattern. The upper electrode UE is located on the insulating pattern. The upper electrode UE may serve as a mask for forming the insulating pattern from the second insulating layer 20.

A third insulating layer 30 covering the upper electrode UE is located on the second insulating layer 20. According to some embodiments, the third insulating layer 30 may be a single silicon oxide layer. A semiconductor pattern of the third transistor T3 is located on the third insulating layer 30. The semiconductor pattern may include a metal oxide. The oxide semiconductor may include a crystalline or amorphous oxide semiconductor. For example, the oxide semiconductor may include metal oxide of zinc (Zn), indium (In), gallium (Ga), tin (Sn), or titanium (Ti) or a mixture of a metal, such as zinc (Zn), indium (In), gallium (Ga), tin (Sn), or titanium (Ti), and an oxide thereof. The oxide semiconductors may include indium-tin oxide (ITO), indium-gallium-zinc oxide (IGZO), zinc oxide (ZnO), indium-zinc oxide (IZO), zinc-indium oxide (ZIO), indium oxide (InO), titanium oxide (TiO), indium-zinc-tin oxide (IZTO), zinc-tin oxide (ZTO), etc.

The semiconductor pattern may include a plurality of areas which are distinguished depending on whether the metal oxide is reduced. An area (hereinafter referred to as a “reduction area”) in which the metal oxide is reduced has higher conductivity than an area (hereinafter referred to as a “non-reduction area”) in which the metal oxide is not reduced. The reduction area substantially has the role of an electrode or a signal line. The non-reduction area corresponds substantially to a channel portion of a transistor. In other words, a portion of the semiconductor pattern may be a channel portion of a transistor, and another portion thereof may be a first electrode or a second electrode of the transistor.

A first electrode S3, a channel part A3, and a second electrode D3 of the third transistor T3 are formed from the semiconductor pattern. The first electrode S3 and the second electrode D3 include a metal reduced from a metal oxide semiconductor. The first electrode S3 and the second electrode D3 may include a metal layer which has a given thickness from an upper surface of the semiconductor pattern and includes the reduced metal.

A fourth insulating layer 40 covering the semiconductor pattern is located on the third insulating layer 30. According to some embodiments, the fourth insulating layer 40 may be a single silicon oxide layer. A third electrode G3 of the third transistor T3 is located on the fourth insulating layer 40. The third electrode G3 may be a portion of a metal pattern. The third electrode G3 of the third transistor T3 overlaps the channel part A3 of the third transistor T3.

According to some embodiments of the present disclosure, the fourth insulating layer 40 may be replaced with an insulating pattern. The third electrode G3 of the third transistor T3 is located on the insulating pattern. According to some embodiments, the third electrode G3 may have the same shape as the insulating pattern in a plan view. According to some embodiments, for convenience of description, one third electrode G3 is illustrated, but the third transistor T3 may include two third electrodes.

A fifth insulating layer 50 covering the third electrode G3 is located on the fourth insulating layer 40. According to some embodiments, the fifth insulating layer 50 may include a silicon oxide layer and a silicon nitride layer. The fifth insulating layer 50 may include a plurality of silicon oxide layers and a plurality of silicon nitride layers, which are alternately stacked.

According to some embodiments, the first electrode and the second electrode of the fourth transistor T4 (refer to FIG. 7) may be formed through the same process as the first electrode S3 and the second electrode D3 of the third transistor T3. Also, the first electrode and the second electrode of the reset transistor ST1 of the sensor FX (refer to FIG. 5) may be simultaneously formed through the same process as the first electrode S3 and the second electrode D3 of the third transistor T3.

At least one insulating layer is further located on the fifth insulating layer 50. As illustrated in FIG. 8, a sixth insulating layer 60 and a seventh insulating layer 70 may be located on the fifth insulating layer 50. The sixth insulating layer 60 and the seventh insulating layer 70 may be organic layers and may have a single-layer structure or a multi-layer structure. Each of the sixth insulating layer 60 and the seventh insulating layer 70 may be a polyimide-based resin layer of a single-layer structure. However, the present disclosure is not limited thereto. For example, the sixth insulating layer 60 and the seventh insulating layer 70 may include at least one of acrylate-based resin, methacrylate-based resin, polyisoprene-based resin, vinyl-based resin, epoxy-based resin, urethane-based resin, cellulose-based resin, siloxane-based resin, polyamide-based resin, or perylene-based resin.

A first connection electrode CNE10 may be located on the fifth insulating layer 50. The first connection electrode CNE10 may be connected to the connection signal line CSL through a first contact hole CH1 penetrating the first to fifth insulating layers 10 to 50, and a second connection electrode CNE20 may be connected to the first connection electrode CNE10 through a contact hole CH2 penetrating the sixth insulating layer 60. According to some embodiments of the present disclosure, at least one of the fifth insulating layer 50 to the seventh insulating layer 70 may be omitted.

The element layer DP_ED includes the red light emitting element ED_R and a pixel defining layer PDL. The red anode electrode R_AE of the red light emitting element ED_R is located on the seventh insulating layer 70. The red anode electrode R_AE of the red light emitting element ED_R may be connected to the second connection electrode CNE20 through a third contact hole CH3 penetrating the seventh insulating layer 70.

A first opening OP1 of the pixel defining layer PDL exposes at least a portion of the red anode electrode R_AE of the red light emitting element ED_R. The first opening OP1 of the pixel defining layer PDL may define a light emitting area PXA. For example, the plurality of pixels PX (refer to FIG. 5) may be arranged on a plane of the display panel DP (refer to FIG. 5) in compliance with a given rule. An area in which the plurality of pixels PX are arranged may be defined as a pixel area, and one pixel area may include the light emitting area PXA and a non-light emitting area NPXA adjacent to the light emitting area PXA. The non-light emitting area NPXA may surround the light emitting area PXA.

A red light emitting layer R_EL is located on the red anode electrode R_AE. The red light emitting layer R_EL may be located only in an area corresponding to the first opening OP1. The red light emitting layer R_EL may be independently formed for each of the plurality of pixels PX. According to some embodiments, the patterned red light emitting layer R_EL is illustrated as an example, but the present disclosure is not limited thereto. A common light emitting layer may be arranged in common in the plurality of pixels PX. In this case, the common light emitting layer may generate a white light or a blue light.

The red cathode electrode R_CA may be located on the red light emitting layer R_EL. The red cathode electrode R_CA is arranged in common in the plurality of pixels PX.

According to some embodiments, a hole transport layer and a hole injection layer may be further located between the red anode electrode R_AE and the red light emitting layer R_EL. Also, an electron transport layer and an electron injection layer may be further located between the red light emitting layer R_EL and the red cathode electrode R_CA.

The encapsulation layer TFE is located on the red cathode electrode R_CA. The encapsulation layer TFE may cover the plurality of pixels PX. According to some embodiments, the encapsulation layer TFE directly covers the red cathode electrode R_CA. According to some embodiments of the present disclosure, the display panel DP may further include a capping layer directly covering the red cathode electrode R_CA. According to some embodiments of the present disclosure, the stacked structure of the red light emitting element ED_R may have a vertically inverted structure in the structure shown in FIG. 8.

As illustrated in FIG. 8, the circuit layer DP_CL may further include a portion of a semiconductor pattern of the sensor driving circuit O_SD (refer to FIG. 7). For convenience of description, the reset transistor ST1 belonging to the semiconductor pattern of the sensor driving circuit O_SD is illustrated. A first electrode STS1, a channel part STA1, and a second electrode STD1 of the reset transistor ST1 are formed from the semiconductor pattern. According to some embodiments of the present disclosure, the semiconductor pattern may include a metal oxide. The first electrode STS1 and the second electrode STD1 include a metal reduced from a metal oxide semiconductor. The first electrode STS1 and the second electrode STD1 may include a metal layer which has a given thickness from an upper surface of the semiconductor pattern and includes the reduced metal. The fourth insulating layer 40 is arranged to cover the first electrode STS1, the channel part STA1, and the second electrode STD1 of the reset transistor ST1. A third electrode STG1 of the reset transistor ST1 is located on the fourth insulating layer 40. According to some embodiments, the third electrode STG1 may be a portion of a metal pattern. The third electrode STG1 of the reset transistor ST1 overlaps the channel part STA1 of the reset transistor ST1. According to some embodiments, for convenience of description, one third electrode STG1 is illustrated, but the reset transistor ST1 may include two third electrodes.

According to some embodiments of the present disclosure, the reset transistor ST1 may be located on the same layer as the third transistor T3. That is, the first electrode STS1, the channel part STA1, and the second electrode STD1 of the reset transistor ST1 may be formed through the same process as the first electrode S3, the channel part A3, and the second electrode D3 of the third transistor T3. The third electrode STG1 of the reset transistor ST1 may be simultaneously formed through the same process as the third electrode G3 of the third transistor T3. According to some embodiments, the first electrode and the second electrode of each of the amplification transistor ST2 and the output transistor ST3 of the sensor driving circuit O_SD may be formed through the same process as the first electrode S1 and the second electrode D1 of the first transistor T1. As the reset transistor ST1 and the third transistor T3 are formed on the same layer through the same process, a process of forming the reset transistor ST1 may not be additionally required, and thus, process efficiency and costs may be reduced. For example, the third electrode STG1 of the reset transistor ST1 corresponds to the j-th sensing control line CLj of FIG. 7. The third electrode G3 of the third transistor T3 corresponds to the j-th compensation scan line SCLj of FIG. 7. Accordingly, even though the j-th sensing control line CLj for providing the sensing control signal CS different from the j-th compensation scan signal SCj provided to the red pixel PXR (refer to FIG. 7) is additionally formed in the sensor FX (refer to FIG. 7), a process for forming only the j-th sensing control line CLj may not be additionally required, and thus, process efficiency may be relatively improved. This may mean that costs are reduced.

The element layer DP_ED may further include the first and second light sensing elements OPD1 and OPD2 (refer to FIG. 7). Below, for convenience of description, the first light sensing element OPD1 is only illustrated in FIG. 8. The first sub-anode electrode O_AE1 of the first light sensing element OPD1 is located on the seventh insulating layer 70. According to some embodiments, the first sub-anode electrode O_AE1 may be electrically connected to the second electrode STD1 of the reset transistor ST1 through a contact hole penetrating the fourth to seventh insulating layers 40 to 70 in a plan view.

A second opening OP2 of the pixel defining layer PDL exposes at least a portion of the first sub-anode electrode O_AE1 of the first light sensing element OPD1. The second opening OP2 of the pixel defining layer PDL may define a sensing area SA. When an area where a first photoelectric conversion layer O_PCL1 is located is referred to as the “sensing area SA”, an area surrounding the sensing area SA may be defined as a non-sensing area NSA. According to some embodiments, a non-pixel area NPA may be defined between the non-sensing area NSA and the non-light emitting area NPXA.

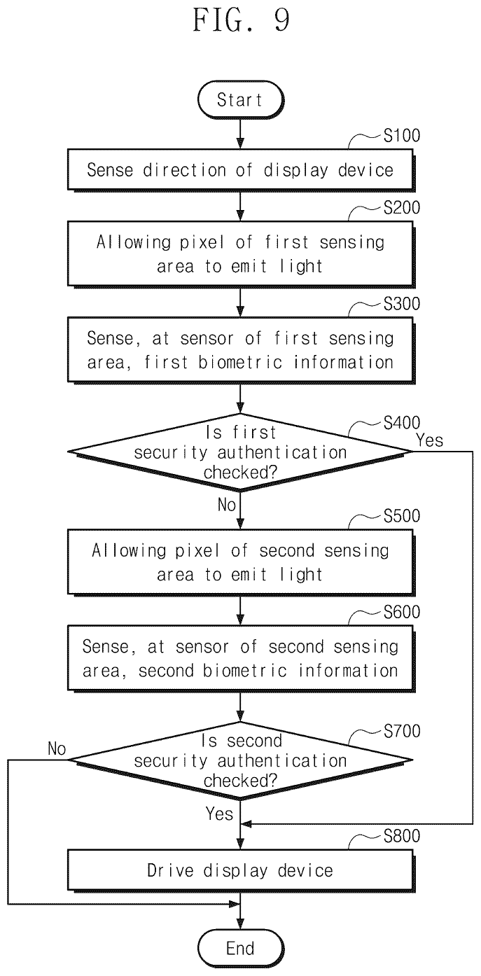

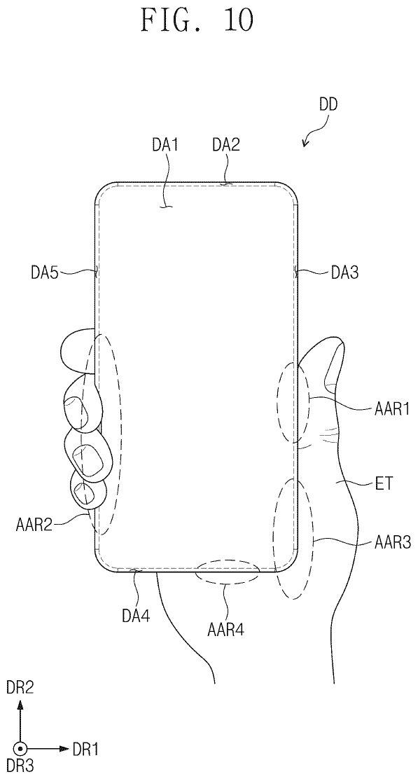

FIG. 9 is a flowchart illustrating a method of controlling a display device according to some embodiments of the present disclosure, and FIG. 10 is a conceptual diagram illustrating a user's hand and a display device according to some embodiments of the present disclosure.

Referring to FIGS. 4, 5, 9, and 10, the user's hand ET may naturally grip the display device DD. The control method of the display device DD according to some embodiments of the present disclosure may easily perform a security authentication operation when the user's hand ET naturally grips the display device DD.

The main driving unit 1000C may further include a sensing unit which senses a direction of the display device DD. The sensing unit may include a gyro sensor.

The sensing unit may sense the direction of the display device DD (S100). In this case, when the display device DD is in the forward direction, the main driving unit 1000C may perform an operation of sensing the fingerprint of the user's hand ET.

The input sensing layer ISL may sense an input made by the user's hand ET. The sensor driving unit 200C may transmit the coordinate signal I-SS to the main driving unit 1000C. The main driving unit 1000C may sense coordinates based on the coordinate signal I-SS.

The main driving unit 1000C may define a first sensing area AAR1 based on the coordinates. In the display area DA, the first sensing area AAR1 may be an area overlapping the thumb of the user's hand ET. The first sensing area AAR1 may overlap the third display area DA3 of the display area DA.

The main driving unit 1000C may control the drive controller 100.

Under control of the drive controller 100, a first pixel belonging to the first sensing area AAR1 from among the plurality of pixels PX may emit a light (S200). The first pixel may include pixels located in the first sensing area AAR1 from among the plurality of pixels PX.

A first sensor belonging to the first sensing area AAR1 from among the plurality of sensors FX may sense first biometric information from the user's hand ET (S300). The first sensor may include sensors located in the first sensing area AAR1 from among the plurality of sensors FX. The first biometric information may include the thumb fingerprint of the user's hand ET. The first sensor may be adjacent to the first pixel. The first sensor may sense the first biometric information based on a light reflected by a ridge or a valley of the thumb of the user's hand ET after the light is emitted from the first pixel.

The main driving unit 1000C may perform a first security authentication check operation based on the first biometric information (S400). The first security authentication check operation may be an operation of matching the first biometric information with stored first authentication information. And the first security authentication check operation may be an operation of determining whether the first biometric information is matched with first authentication information stored in advance.

When the first security authentication is checked, the main driving unit 1000C may drive the display device DD.

The first authentication information may include the first biometric information and information corresponding to the first sensing area AAR1.

According to the present disclosure, the main driving unit 1000C may permit the security authentication only when the corresponding biometric information is matched in the specified area AR1 and may drive the display device DD (S800). For example, the main driving unit 1000C may permit the security authentication only when the thumb of the user's hand ET is recognized in the specified area AR1 corresponding to a thumb location of the third display area DA3 of the display area DA and may not permit the security authentication when the thumb is recognized in any other area. Accordingly, the display device DD with relatively improved security strength and a control method thereof may be provided.

When the first security authentication is not checked, the main driving unit 1000C may define a second sensing area AAR2 based on the coordinates. In the display area DA, the second sensing area AAR2 may be an area overlapping at least one of the index finger, the middle finger, the ring finger, or the little finger of the user's hand ET. The second sensing area AAR2 may overlap the fifth display area DA5 of the display area DA.

Under control of the drive controller 100, a second pixel belonging to the second sensing area AAR2 from among the plurality of pixels PX may emit a light (S500). The second pixel may include pixels located in the second sensing area AAR2 from among the plurality of pixels PX. The operation in which the second pixel in the second sensing area AAR2 emits the light may be performed when the first biometric information and the first authentication information are not matched.

A second sensor belonging to the second sensing area AAR2 from among the plurality of sensors FX may sense second biometric information from the user's hand ET (S600). The second sensor may include sensors located in the second sensing area AAR2 from among the plurality of sensors FX. The second biometric information may include the fingerprint of at least one of the index finger, the middle finger, the ring finger, or the little finger of the user's hand ET. The second sensor may be adjacent to the second pixel. The second sensor may sense the second biometric information based on a light reflected by a ridge or a valley of the fingerprint of the user's hand ET after the light is emitted from the second pixel.

The main driving unit 1000C may perform a second security authentication check operation based on the second biometric information (S700). The second security authentication check operation may be an operation of matching the second biometric information with stored second authentication information. And the second security authentication check operation may be an operation of determining whether the second biometric information is matched with second authentication information stored in advance. The second authentication information may be different from the first authentication information.

When the second security authentication is checked, the main driving unit 1000C may drive the display device DD. That is, when the first biometric information is matched with the first authentication information or when the second biometric information is matched with the second authentication information, the main driving unit 1000C may drive the display panel DP.

According to the present disclosure, when the user's hand ET grips the display device DD, the main driving unit 1000C may first sense an area where the thumb is placed and may sense the first biometric information in the first sensing area AAR1. The security authentication operation may be performed based on the thumb of the user's hand ET; when not matched, the second biometric information may be sensed in the second sensing area AAR2 by sensing any other area where at least one of the index finger, the middle finger, the ring finger, or the little finger is placed. The security authentication operation may be performed based on at least one of the index finger, the middle finger, the ring finger, or the little finger of the user's hand ET. The reliability of security authentication may be relatively improved by performing the security authentication operation consecutively two times. Accordingly, the display device DD with relatively improved security strength and a control method thereof may be provided.

Also, according to the present disclosure, as four surfaces of the display device DD are bent, the second to fifth display areas DA2, DA3, DA4, and DA5 (refer to FIG. 1) may be formed. In general, when the user grips the display device DD, the user's hand ET may warp around the third display area DA3 and the fifth display area DA5. When the user grips and uses the display device DD, the security authentication operation such as a login may be required; in this case, the user's hand ET may easily perform the security authentication operation without separate location movement, with the display device DD gripped by the user's hand ET. Accordingly, the display device DD in which the convenience of user is relatively improved and a control method thereof may be provided.

The second authentication information may include the second biometric information and information corresponding to the second sensing area AAR2.

According to the present disclosure, the main driving unit 1000C may permit the security authentication only when the corresponding biometric information is matched in the specified area AR2 and may drive the display device DD (S800). For example, the main driving unit 1000C may permit the security authentication only when the index finger of the user's hand ET is recognized in the specified area AR2 corresponding to a index finger location of the fifth display area DA5 of the display area DA and may not permit the security authentication when the index finger is recognized in any other area. Accordingly, the display device DD with relatively improved security strength and a control method thereof may be provided.

Additionally, the display device DD may further perform the security authentication operation. The main driving unit 1000C may define a third sensing area AAR3 or a fourth sensing area AAR4 based on the coordinates. Each of the third sensing area AAR3 and the fourth sensing area AAR4 may be an area overlapping a part of the palm of the user's hand ET. The third sensing area AAR3 may overlap the third display area DA3 of the display area DA, and the fourth sensing area AAR4 may overlap the fourth display area DA4 of the display area DA.

Under control of the drive controller 100, a third pixel belonging to the third sensing area AAR3 or the fourth sensing area AAR4 from among the plurality of pixels PX may emit a light. The third pixel may include pixels located in the third sensing area AAR3 or the fourth sensing area AAR4 from among the plurality of pixels PX.

A third sensor belonging to the third sensing area AAR3 or the fourth sensing area AAR4 from among the plurality of sensors FX may sense third biometric information from the user's hand ET. The third sensor may include sensors located in the third sensing area AAR3 or the fourth sensing area AAR4 from among the plurality of sensors FX. The third biometric information may include information about a part of the palm of the user's hand ET. The third sensor may be adjacent to the third pixel. The third sensor may sense the third biometric information based on a light reflected by a ridge or a valley of the fingerprint of the user's hand ET after the light is emitted from the third pixel.

The main driving unit 1000C may perform a third security authentication check operation based on the third biometric information. The third security authentication check operation may be an operation of matching the third biometric information with stored third authentication information. And the third security authentication check operation may be an operation of determining whether the third biometric information is matched with third authentication information stored in advance. The third authentication information may be different from the first authentication information and the second authentication information.

When the third security authentication is checked, the main driving unit 1000C may drive the display device DD.

An example in which the authentication operation is performed in order of the thumb, the index finger, and the palm of the user's hand ET is described with reference to FIG. 10, but the order of security authentication operations according to some embodiments of the present disclosure is not limited thereto. For example, the security authentication operation may be performed in order of the thumb, the palm, and the index finger.

Also, an example in which the display device DD is driven when the security authentication is checked in one of the three security authentication check operations is described with reference to FIG. 10, but the control method of the display device DD according to some embodiments of the present disclosure is not limited thereto. For example, the display device DD may operate only when the security authentication is checked in at least two of the three security authentication check operations. In this case, when the first security authentication is checked in operation S400 (i.e., in the first security authentication check operation), operation S700, that is, the second security authentication check operation may be performed, and the display device DD may operate when the second security authentication is checked. For example, the display device DD may check at least two biometric information (e.g., the thumb and the index finger) of the user's hand ET in a given order, and the display device DD may operate when each of the two biometric information is matched. The main driving unit 1000C may operate based on a combination of the first security authentication operation of sensing the thumb and the second security authentication operation of sensing at least one of the index finger, the middle finger, the ring finger, or the little finger depending on the security strength and/or the convenience of user.

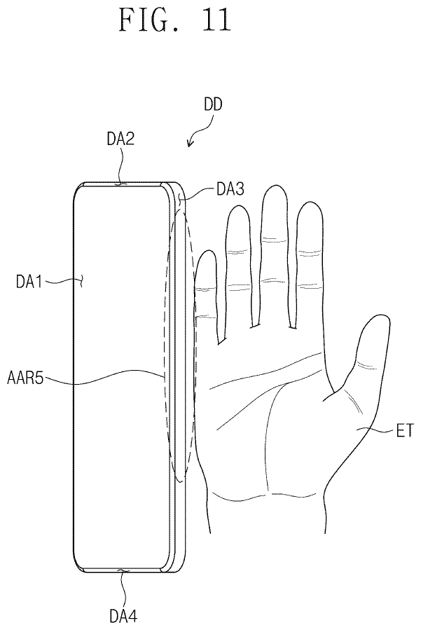

FIG. 11 is a conceptual diagram illustrating a user's hand and a display device according to some embodiments of the present disclosure.

Referring to FIGS. 4, 5, and 11, the main driving unit 1000C may define a fifth sensing area AAR5 based on coordinates sensed by the input sensing layer ISL. The fifth sensing area AAR5 may overlap the third display area DA3 of the display area DA.

Under control of the drive controller 100, a fifth pixel belonging to the fifth sensing area AAR5 from among the plurality of pixels PX may emit a light. The fifth pixel may include pixels located in the fifth sensing area AAR5 from among the plurality of pixels PX.

A fifth sensor belonging to the fifth sensing area AAR5 from among the plurality of sensors FX may sense fifth biometric information from the user's hand ET. The fifth sensor may include sensors located in the fifth sensing area AAR5 from among the plurality of sensors FX. The fifth biometric information may include information about the edge of the user's hand ET. The fifth sensor may be adjacent to the fifth pixel. The fifth sensor may sense the fifth biometric information based on a light reflected by the edge of the user's hand ET after the light is emitted from the fifth pixel.

The main driving unit 1000C may perform a fourth security authentication check operation based on the fifth biometric information. The fourth security authentication check operation may be an operation of matching the fifth biometric information with stored fifth authentication information.

When the fourth security authentication is checked, the main driving unit 1000C may drive the display device DD.

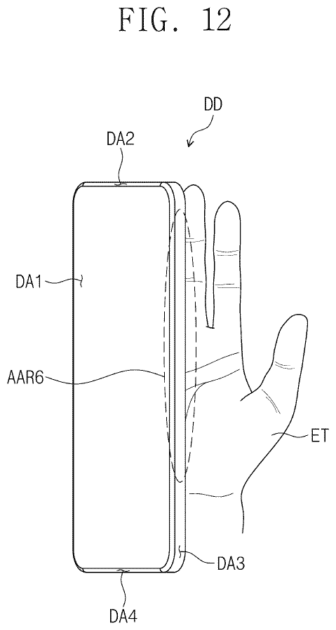

FIG. 12 is a conceptual diagram illustrating a user's hand and a display device according to some embodiments of the present disclosure.

Referring to FIGS. 4, 5, and 11, the main driving unit 1000C may define a sixth sensing area AAR6 based on coordinates sensed by the input sensing layer ISL. The sixth sensing area AAR6 may overlap the third display area DA3 of the display area DA.

Under control of the drive controller 100, a sixth pixel belonging to the sixth sensing area AAR6 from among the plurality of pixels PX may emit a light. The sixth pixel may include pixels located in the sixth sensing area AAR6 from among the plurality of pixels PX.

A sixth sensor belonging to the sixth sensing area AAR6 from among the plurality of sensors FX may sense sixth biometric information from the user's hand ET. The sixth sensor may include sensors located in the sixth sensing area AAR6 from among the plurality of sensors FX. The sixth biometric information may include information about the finger and the palm of the user's hand ET. The sixth sensor may be adjacent to the sixth pixel. The sixth sensor may sense the sixth biometric information based on a light reflected by the finger and the palm of the user's hand ET after the light is emitted from the sixth pixel.

The main driving unit 1000C may perform a fifth security authentication check operation based on the sixth biometric information. The fifth security authentication check operation may be an operation of matching the sixth biometric information with stored sixth authentication information.

When the fifth security authentication is checked, the main driving unit 1000C may drive the display device DD.

According to some embodiments, when a user's hand grips a display device, a main driving unit may first sense an area where the thumb is placed and may sense first biometric information in a first sensing area. A security authentication operation may be performed based on the thumb of the user's hand; when not matched, second biometric information may be sensed in a second sensing area by sensing any other area where at least one of the index finger, the middle finger, the ring finger, or the little finger is placed. The security authentication operation may be performed based on at least one of the index finger, the middle finger, the ring finger, or the little finger of the user's hand The reliability of security authentication may be relatively improved by performing the security authentication operation consecutively two times. Accordingly, the display device with relatively improved security strength and a control method thereof may be provided.

While aspects of some embodiments of the present disclosure have been described with reference to embodiments thereof, it will be apparent to those of ordinary skill in the art that various changes and modifications may be made thereto without departing from the spirit and scope of the present disclosure as set forth in the following claims, and their equivalents.

What is claimed is:

1. A method of controlling of a display device, the display device including a display panel in which a display area is defined and including a plurality of pixels and a plurality of sensors, and an input sensing layer on the display panel and configured to sense an external input, the method comprising:
allowing a first pixel among the plurality of pixels to emit a light, wherein the first pixel is in a first sensing area of the display area, which overlaps the external input;
sensing, at a first sensor among the plurality of sensors, first biometric information from the external input, wherein the first sensor is in the first sensing area;
matching the first biometric information with stored first authentication information;
allowing a second pixel among the plurality of pixels to emit a light, wherein the second pixel is in a second sensing area of the display area, which overlaps the external input and is different from the first sensing area;
sensing, at a second sensor among the plurality of sensors, second biometric information different from the first biometric information from the external input, wherein the second sensor is in the second sensing area;
matching the second biometric information with second authentication information different from the stored first authentication information; and
based on the first biometric information matching the first authentication information or the second biometric information matching the second authentication information, driving the display panel.

2. The method of claim 1, wherein allowing of the second pixel to emit the light is performed based on the first biometric information and the first authentication information not matching with each other.

3. The method of claim 1, wherein the external input includes a hand of a user, and
wherein the first biometric information includes a fingerprint of a thumb of the hand of the user.

4. The method of claim 3, wherein the second biometric information includes a fingerprint of an index finger of the hand of the user.

5. The method of claim 3, wherein the second biometric information includes a palm of the hand of the user.

6. The method of claim 1, wherein the display device further includes a sensing unit configured to sense a direction of the display device,
wherein the method further comprises:
sensing, at the sensing unit, the direction of the display device, and
wherein the sensing of the direction of the display device includes:
based on the display device being in a forward direction, allowing the first pixel of the first sensing area to emit the light.

7. The method of claim 1, wherein allowing of the first pixel to emit the light includes:
sensing, at the input sensing layer, coordinates of the external input;
defining the first sensing area based on the coordinates; and
allowing the first pixel overlapping the first sensing area from among the plurality of pixels to emit the light.

8. The method of claim 1, wherein the first pixel is adjacent to the first sensor, and the second pixel is adjacent to the second sensor.

9. The method of claim 1, wherein the display area includes:
a first area including a first edge, a second edge extending in a direction intersecting the first edge, a third edge parallel to the first edge, and a fourth edge parallel to the second edge;
a second area extending from the first edge, wherein at least a portion of the second area is bent;
a third area extending from the second edge, wherein at least a portion of the third area is bent;
a fourth area extending from the third edge, wherein at least a portion of the fourth area is bent; and
a fifth area extending from the fourth edge, wherein at least a portion of the fifth area is bent.

10. The method of claim 9, wherein the first sensing area and the second sensing area overlap the third area.

11. The method of claim 9, wherein the first sensing area overlaps the third area, and the second sensing area overlaps the fifth area.

12. The method of claim 9, wherein the first sensing area overlaps the third area, and the second sensing area overlaps the fourth area.

13. The method of claim 1, wherein the first authentication information includes the first biometric information and information corresponding to the first sensing area.

14. The method of claim 1, further comprising:
allowing a third pixel among the plurality of pixels to emit a light, wherein the third pixel is in a third sensing area of the display area, which overlaps the external input and is different from the first sensing area and the second sensing area;
sensing, at a third sensor among the plurality of sensors, third biometric information different from the first biometric information and the second biometric information from the external input, wherein the third sensor is in the third sensing area; and
matching the third biometric information with third authentication information different from the stored first authentication information and the second authentication information.

15. A display device comprising:
a display panel in which a display area and a non-display area adjacent to the display area are defined and including a plurality of pixels and a plurality of sensors;
an input sensing layer on the display panel and configured to sense an external input;
a drive controller configured to drive the display panel; and
a readout circuit electrically connected to the plurality of sensors and configured to output a sensing signal to the drive controller,
wherein the external input overlaps the display area and defines a first sensing area and a second sensing area different from the first sensing area,
wherein a first sensor in the first sensing area from among the plurality of sensors is configured to sense first biometric information from the external input,
wherein the drive controller compares the first biometric information and stored first authentication information,
wherein a second sensor in the second sensing area from among the plurality of sensors is configured to sense second biometric information from the external input,
wherein the drive controller is configured to compare the second biometric information and stored second authentication information, and
wherein, when the first biometric information is matched with the first authentication information or when the second biometric information is matched with the second authentication information, the drive controller is configured to drive the display panel.

16. The display device of claim 15, wherein the external input includes an input from a hand of a user, and
wherein the first biometric information includes a thumb fingerprint corresponding to the hand of the user, and
wherein the second biometric information includes a palm print corresponding to the hand of the user.

17. The display device of claim 15, wherein the display area includes:
a first area including a first edge, a second edge extending in a direction intersecting the first edge, a third edge parallel to the first edge, and a fourth edge parallel to the second edge;
a second area extending from the first edge, wherein at least a portion of the second area is bent;
a third area extending from the second edge, wherein at least a portion of the third area is bent;
a fourth area extending from the third edge, wherein at least a portion of the fourth area is bent; and
a fifth area extending from the fourth edge, wherein at least a portion of the fifth area is bent.

18. The display device of claim 17, wherein the first sensing area and the second sensing area overlap the third area.

19. The display device of claim 17, wherein the first sensing area overlaps the third area, and the second sensing area overlaps the fifth area.

20. The display device of claim 15, wherein the first authentication information includes the first biometric information and information corresponding to the first sensing area.
